(19) United States
(12) Patent Application Publication
(10) Pub. No.: US 2014/0240602 A1
(43) Pub. Date: Aug. 28, 2014

(54) SCENE CHANGE DETECTION DEVICE, DISPLAY DEVICE, SCENE CHANGE DETECTION METHOD, AND SCENE CHANGE DETECTION PROGRAM

(71) Applicant: Sharp Kabushiki Kaisha, Osaka-shi, Osaka (JP)

(72) Inventor: Yoshimitsu Murahashi, Osaka-shi (JP)

(73) Assignee: Sharp Kabushiki Kaisha, Osaka-shi, Osaka (JP)

(21) Appl. No.: 14/349,404

(22) PCT Filed: Oct. 3, 2012
(86) PCT No.: PCT/JP2012/075712

§ 371 Date: Apr. 3, 2014

(30) Foreign Application Priority Data
Oct. 4, 2011 (JP) 2011-220216

(51) Int. Cl. H04N 5/14

(52) U.S. Cl. CPC H04N 5/147
USPC 348/700

(57) ABSTRACT

A scene change detection device includes an inter-frame difference calculation unit configured to calculate, based on an image signal, an inter-frame difference value corresponding to an inter-frame pixel value difference, and a determination unit configured to determine whether or not a target frame is the first frame in a video scene that has changed, by referring to a first value and a comparative value, the first value being an inter-frame difference value between the target frame and a frame other than the target frame, the comparative value being derived from a second value that is an inter-frame difference value between frames other than the target frame.

### TECHNICAL FIELD

The present invention relates to a scene change detection device, a display device, a scene change detection method, and a scene change detection program.

This application claims priority to Japanese Patent Application No. 2011-220216, filed Oct. 4, 2011, the content of which is incorporated herein by reference.

### BACKGROUND ART

Hitherto, scene changes have been detected from image signals. For example, PTL 1 describes a scene change detection unit described below. In PTL 1, the scene change detection unit delays an image signal SDin by one frame to generate a delayed image signal SDa, and calculates a difference value in luminance level between two frames on each pixel in accordance with the image signal SDin and the delayed image signal SDa to calculate a difference average value Dav indicating the average value of the obtained difference values.

The scene change detection unit further calculates a luminance average value Yav that is an average value of the luminance levels in one frame on the basis of the luminance level of each pixel in accordance with the image signal SDin. Further, the scene change detection unit normalizes the difference average value Dav with a luminance average value Yav indicating the brightness in the image to calculate a normalized value.

The scene change detection unit has a preset threshold value. As a result of comparison between the normalized value and the threshold value, if the normalized value is larger than the threshold value, the scene change detection unit determines that a scene changes. On the other hand, if the normalized value is less than or equal to the threshold value, the scene change detection unit determines that a scene does not change.

### CITATION LIST

### Patent Literature

PTL 1: Japanese Unexamined Patent Application Publication No. 2008-271237

### SUMMARY OF INVENTION

### Technical Problem

The scene change detection unit described in PTL 1 normalizes a difference average value in accordance with the brightness of an image, and tries to make improvements so as not to rely on luminance. However, since the threshold value is a fixed value, in some cases, the scene change detection unit may even detect a change in the image caused by panning, which refers to the rotation in a plane of a fixed camera, or caused by zooming as a scene change, and has a problem of low scene change detection accuracy.

Accordingly, an aspect of the present invention has been made in light of the foregoing problem, and it is an object of an aspect of the present invention to provide a scene change detection device, a display device, a scene change detection method, and a scene change detection program that enable high-accuracy detection of scene changes.

### Solution to Problem

(1) An aspect of the present invention has been made in order to overcome the problem described above, and an aspect of the present invention provides a scene change detection device including an inter-frame difference calculation unit configured to calculate, based on an image signal, an inter-frame difference value corresponding to an inter-frame pixel value difference, and a determination unit configured to determine whether or not a target frame is the first frame in a video scene that has changed, by referring to a first value and a comparative value, the first value being an inter-frame difference value between the target frame and a frame other than the target frame, the comparative value being derived from a second value that is an inter-frame difference value between frames other than the target frame.

(2) Further, an aspect of the present invention provides the scene change detection device described above, in which the comparative value is a value that is based on an inter-frame difference value for neighboring frames of the target frame.

(3) Further, an aspect of the present invention provides the scene change detection device described above, in which the comparative value is a value that is based on an inter-frame difference value for a series of frames adjacent to the target frame.

(4) Further, an aspect of the present invention provides the scene change detection device described above, in which the comparative value is a value that is based on an inter-frame difference value for frames preceding the target frame.

(5) Further, an aspect of the present invention provides the scene change detection device described above, further including an adjustment unit configured to adjust a value of the inter-frame difference value of the target frame in accordance with the inter-frame difference value between frames other than the target frame to calculate the comparative value, in which the determination unit determines whether or not a scene change has occurred in the target frame, in accordance with the inter-frame difference value and the comparative value calculated by the adjustment unit.

(6) Further, an aspect of the present invention provides the scene change detection device described above, in which the determination unit determines whether or not the target frame is the first frame in a video scene that has changed, by classifying the inter-frame difference value of the target frame into two groups in accordance with the comparative value.

(7) Further, an aspect of the present invention provides the scene change detection device described above, in which the determination unit includes a threshold value calculation unit configured to calculate a threshold value based on the comparative value, and a comparison unit configured to determine whether or not the target frame is the first frame in a video scene that has changed, based on a comparison between the inter-frame difference value and the threshold value calculated by the threshold value calculation unit.

(8) Further, an aspect of the present invention provides the scene change detection device described above, in which the threshold value calculation unit calculates the threshold value so that the threshold value increases as the comparative value increases.

(9) Further, an aspect of the present invention provides the scene change detection device described above, in which the threshold value calculation unit sets a threshold value for a frame subsequent to the target frame to be higher than a threshold value that is based on the comparative value for the frame subsequent to the target frame in a case where the determination unit determines that the target frame is the first frame in a video scene that has changed.

(10) Further, an aspect of the present invention provides the scene change detection device described above, in which the threshold value calculation unit sets a threshold value for a frame subsequent to the target frame to be equal to a threshold value that is based on the comparative value for the frame subsequent to the target frame in a case where the determination unit determines that the target frame is not the first frame in a video scene that has changed.

(11) Further, an aspect of the present invention provides the scene change detection device described above, in which the threshold value calculation unit includes a low threshold value calculation unit configured to calculate a low threshold value based on the comparative value, a high threshold value calculation unit configured to calculate, based on the comparative value, a high threshold value larger than the low threshold value calculated by the low threshold value calculation unit based on the comparative value, and a selection unit configured to select the high threshold value as the threshold value for the target frame in a case where the comparison unit determines that a scene change has occurred in a frame preceding the target frame, and selects the low threshold value as the threshold value for the target frame in a case where the comparison unit determines that no scene changes have occurred in a frame preceding the target frame.

(12) Further, an aspect of the present invention provides the scene change detection device described above, in which the low threshold value calculation unit calculates the low threshold value by applying the comparative value to a predetermined first function, the high threshold value calculation unit calculates the high threshold value by applying the comparative value to a predetermined second function, and in a case where the comparative value is a value greater than or equal to 0, the second function has a return value greater than or equal to a return value of the first function with respect to an equal comparative value.

(13) Further, an aspect of the present invention provides the scene change detection device described above, further including a signal acquisition unit configured to acquire a known scene change signal indicating a known scene change, in which the threshold value calculation unit calculates a threshold value in accordance with the comparative value, the known scene change signal acquired by the signal acquisition unit, and a determination result obtained by the comparison unit.

(14) Further, an aspect of the present invention provides the scene change detection device described above, in which the threshold value calculation unit includes a coefficient changing unit configured to change a coefficient of a third function in accordance with the known scene change signal and a determination result obtained by the comparison unit, and the threshold value calculation unit calculates a threshold value by applying the comparative value to the third function having the coefficient changed by the coefficient changing unit.

(15) Further, an aspect of the present invention provides the scene change detection device described above, in which the determination unit determines whether or not the target frame is the first frame in a video scene that has changed, by applying the inter-frame difference value of the target frame and the comparative value to a pre-established neural network.

(16) Further, an aspect of the present invention provides the scene change detection device described above, in which the inter-frame difference calculation unit includes a delay unit configured to delay an image signal by one or more frames, a difference calculation unit configured to compute a difference between an input and output of the delay unit, an absolute value calculation unit configured to calculate an absolute value of the difference, and a cumulative summation unit configured to calculate a sum value of absolute values of differences within an effective pixel section.

(17) Further, an aspect of the present invention provides a display device including the scene change detection device described above.

(18) Further, an aspect of the present invention provides a scene change detection method executed by a scene change detection device. The scene change detection method includes an inter-frame difference calculation procedure of calculating, based on an image signal, an inter-frame difference value corresponding to an inter-frame pixel value difference; and a determination procedure of determining whether or not a target frame is the first frame in a video scene that has changed, by referring to a first value and a comparative value, the first value being an inter-frame difference value between the target frame and a frame other than the target frame, the comparative value being derived from a second value that is an inter-frame difference value between frames other than the target frame.

(19) Further, an aspect of the present invention provides a scene change detection program for causing a computer to execute an inter-frame difference calculating step of calculating, based on an image signal, an inter-frame difference value corresponding to an inter-frame pixel value difference; and a step of determining whether or not a target frame is the first frame in a video scene that has changed, by referring to a first value and a comparative value, the first value being an inter-frame difference value between the target frame and a frame other than the target frame, the comparative value being derived from a second value that is an inter-frame difference value between frames other than the target frame.

### Advantageous Effects of Invention

According to an aspect of this invention, a scene change can be detected with high accuracy.

### BRIEF DESCRIPTION OF DRAWINGS

FIG. 1 is a schematic block diagram of a display device according to a first embodiment.

FIG. 2 is a schematic block diagram of a liquid crystal display unit according to the first embodiment.

FIG. 3 is a schematic block diagram of a scene change detection unit according to the first embodiment.

FIG. 4 is a diagram depicting a calculation process for an inter-frame difference value D.

FIG. 5 is a schematic block diagram of a determination unit according to the first embodiment.

FIG. 6 is a diagram illustrating an example of the relationship between the inter-frame difference value D and a comparative value Da.

FIG. 7 is a diagram depicting an issue raised in the description of determination using an existing threshold value.

FIG. 8 is a diagram depicting determination using a threshold value T according to this embodiment.

FIG. 9 is a flowchart illustrating an example of the flow of a video saving process of a display device according to the first embodiment.

FIG. 10 is a flowchart illustrating an example of the flow of a scene change detection process in step S102 in FIG. 9.

FIG. 11 is a flowchart illustrating an example of the flow of a video reproduction process of the display device according to the first embodiment.

FIG. 12 is a schematic block diagram of a display device according to a second embodiment.

FIG. 13 is a schematic block diagram of a scene change detection unit according to the second embodiment.

FIG. 14 is a schematic block diagram of a determination unit according to the second embodiment.

FIG. 15 is a diagram illustrating relationships between a high threshold value T_{H} and the comparative value Da and between a low threshold value T_{L} and the comparative value Da.

FIG. 16 is a diagram illustrating an example of the relationship among the inter-frame difference value D, the threshold value T, and the number of frames in a case where a panning scene begins immediately after a scene change.

FIG. 17 is a flowchart illustrating an example of the flow of a process of the scene change detection unit according to the second embodiment.

FIG. 18 is a schematic block diagram of a display device according to a third embodiment.

FIG. 19 is a schematic block diagram of a scene change detection unit according to the third embodiment.

FIG. 20 is a schematic block diagram of a determination unit according to the third embodiment.

FIG. 21 is a flowchart illustrating an example of the flow of a process of the scene change detection unit according to the third embodiment.

FIG. 22 is a schematic block diagram of a display device according to a fourth embodiment.

FIG. 23 is a schematic block diagram of a scene change detection unit according to the fourth embodiment.

FIG. 24 is a schematic block diagram of a determination unit according to the fourth embodiment.

FIG. 25 is a flowchart illustrating an example of the flow of a process of the scene change detection unit according to the fourth embodiment.

### DESCRIPTION OF EMBODIMENTS

### First Embodiment

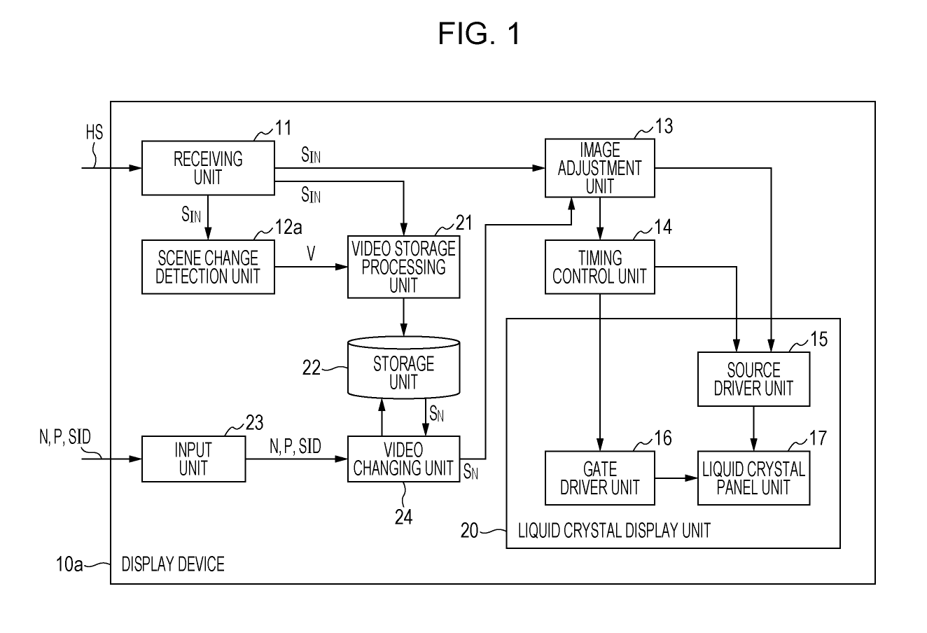

Embodiments of the present invention will be described in detail hereinafter with reference to the drawings. FIG. 1 is a schematic block diagram of a display device 10a according to a first embodiment. The display device 10a includes a receiving unit 11, a scene change detection unit 12a, an image adjustment unit 13, a timing control unit 14, a liquid crystal display unit 20, a video storage processing unit 21, a storage unit 22, an input unit 23, and a video changing unit 24. The liquid crystal display unit 20 includes a source driver unit 15, a gate driver unit 16, and a liquid crystal panel unit 17.

By way of example, the receiving unit 11 receives high-frequency signals HS on a plurality of channels for digital television broadcasting, which are supplied from an antenna (not illustrated). The receiving unit 11 extracts a high-frequency signal on a desired channel from the received high-frequency signals HS, converts the extracted high-frequency signal into a baseband signal, and converts the converted baseband signal into a digital signal at a predetermined sampling frequency.

The receiving unit 11 may have a function to receive high-frequency signals on a plurality of channels for analog television broadcasting, which are supplied from the antenna (not illustrated), and to convert the high-frequency signals into digital signals.

The receiving unit 11 extracts a digital data MPEG (Moving Picture Experts Group)-2 transport stream (hereinafter referred to as “MPEG-2 TS”) signal from the converted digital signal.

The receiving unit 11 extracts a TS (Transport Stream) packet from the MPEG-2 TS signal, and decodes data of a video signal and an audio signal. The following description will be focused on only the processing of a video signal, and no description will be given of the processing of an audio signal.

The receiving unit 11 converts the decoded video signal from an interlaced signal to a progressive signal. Then, the receiving unit 11 supplies a video signal S_{IN} converted into a progressive signal to the scene change detection unit 12a and the video storage processing unit 21. Here, by way of example, the video signal S_{IN} is a progressive signal including a luminance signal and color difference signals (Cb and Cr) of pixels arranged adjacent in the main scanning direction (lateral direction, horizontal direction) of the image, a horizontal synchronization signal HSYNC, and a vertical synchronization signal VSYNC.

The scene change detection unit 12a receives the video signal S_{IN} supplied from the receiving unit 11. The scene change detection unit 12a performs a process described below to detect whether or not each of the frames constituting the received video signal S_{IN} is a scene change, and supplies a scene change signal V indicating a detection result to the video storage processing unit 21.

The storage unit 22 is a high-capacity storage device like a hard disk storage device.

The video storage processing unit 21 causes the storage unit 22 to store each of the frames constituting the video signal S_{IN}, and scene change information indicating whether or not a scene change has occurred in the frame in question (whether or not the frame in question is the first frame after a scene has changed in the video) in association with each other, in accordance with the scene change signal V supplied from the scene change detection unit 12a and the video signal S_{IN} supplied from the receiving unit 11. Further, the video storage processing unit 21 generates, for each frame in which it is determined that a scene change has occurred, scene identification information (for example, information indicating how many scenes are present before the scene in question in the video) SID identifying the scene. Then, the video storage processing unit 21 causes the scene identification information SID and frame order information indicating the ordinal number of the frame in question in the video to be stored in association with each other.

The input unit 23 receives the input of a change-to-next-scene signal N indicating a change to the next scene from a remote controller (hereinafter referred to as the remote control) (not illustrated) via infrared communication, and outputs the received change-to-next-scene signal N to the video changing unit 24.

Further, the input unit 23 receives the input of a change-to-previous-scene signal P indicating a change to the previous scene from the remote control (not illustrated) via infrared communication, and outputs the received change-to-previous-scene signal P to the video changing unit 24.

The input unit 23 further receives the selection of a scene from the remote control (not illustrated) via infrared communication, and outputs scene identification information SID identifying the received scene to the video changing unit 24.

The video changing unit 24 reads next-scene video signals S_{N} of the next and subsequent scenes from the storage unit 22 in accordance with the change-to-next-scene signal input from the input unit 23. Specifically, for example, the video changing unit 24 sequentially reads frames from the storage unit 22, starting from the frame that is to be displayed after the currently displayed frame and that is the closest to the currently displayed frame among the frames corresponding to scene change information indicating scene changes. Then, the video changing unit 24 supplies the sequentially read frames to the image adjustment unit 13 as next-scene video signals S_{N}.

The video changing unit 24 reads previous-scene video signal Sₚ of the preceding and previous scenes from the storage unit 22 in accordance with the change-to-previous-scene signal input from the input unit 23. Specifically, for example, the video changing unit 24 sequentially reads frames from the storage unit 22, starting from the frame that has been displayed before the currently displayed frame and that is the closest to the currently displayed frame among the frames corresponding to scene change information indicating scene changes. Then, the video changing unit 24 supplies the sequentially read frames to the image adjustment unit 13 as previous-scene video signals S_{P}.

The video changing unit 24 references the frame order information corresponding to the scene identification information SID input from the input unit 23, and sequentially reads video signals, starting from the frame having an ordinal number indicated by the referenced frame order information from the storage unit 22. Then, the video changing unit 24 supplies the sequentially read video signals to the image adjustment unit 13.

The image adjustment unit 13 performs a scaling process to adjust the number of pixels of the video signal S_{IN} supplied from the receiving unit 11 or the signal supplied from the video changing unit 24 in accordance with the resolution of the display unit. The image adjustment unit 13 converts the scaled video signal into RGB signals (color video signals of Red, Green, and Blue). The image adjustment unit 13 supplies the RGB signals to the timing control unit 14 and the source driver unit 15 in the liquid crystal display unit 20.

If the television broadcasting signal supplied from the antenna (not illustrated) is a progressive signal, the image adjustment unit 13 does not perform the conversion described above from an interlaced signal to a progressive signal. In this case, the image adjustment unit 13 performs a scaling process to adjust the number of pixels of a video signal S_{CUT} in accordance with the resolution of the display unit.

The timing control unit 14 generates a clock signal and the like for distributing the video data to be supplied to the liquid crystal panel unit 17 over the pixels on the plane. The timing control unit 14 supplies the generated clock signal to the source driver unit 15 and the gate driver unit 16 in the liquid crystal display unit 20.

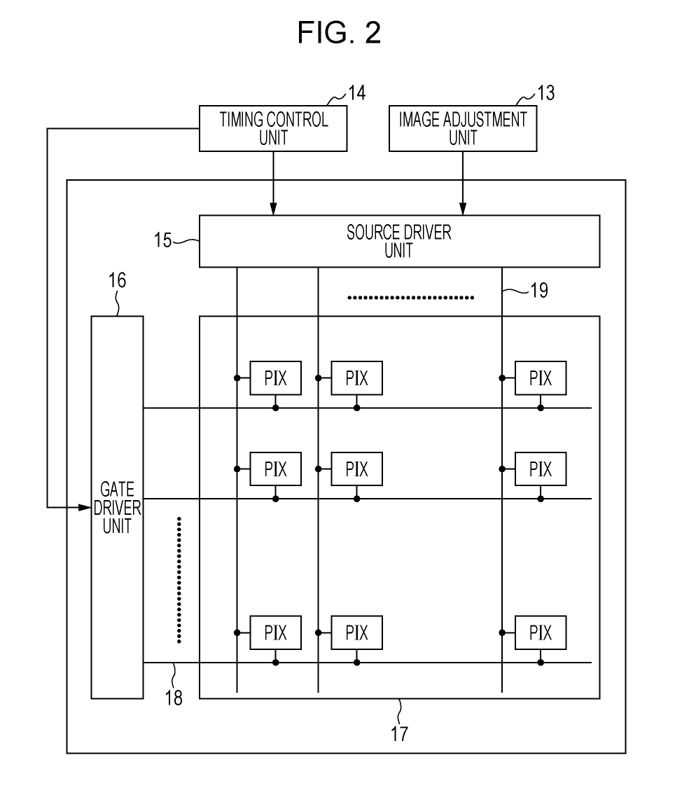

FIG. 2 is a schematic block diagram of the liquid crystal display unit 20 according to the first embodiment. The liquid crystal display unit 20 is an active matrix display device, by way of example. The liquid crystal display unit 20 includes the liquid crystal panel unit 17 having pixels PIX arranged in a matrix, gate lines 18, source lines 19, the gate driver unit 16 that drives the gate lines 18, and the source driver unit 15 that drives the source lines 19.

The source driver unit 15 generates gradation voltages for driving liquid crystal from the RGB signals supplied from the image adjustment unit 13. The source driver unit 15 holds the gradation voltages in an internal hold circuit for the respective source lines 19.

Upon receiving a clock signal supplied from the timing control unit 14, the source driver unit 15 supplies a gradation voltage (source signal) to sub-pixels (not illustrated) in each of pixels PIX in a vertical array on the screen through the corresponding one of the source lines 19 of the liquid crystal panel unit 17 and TFTs (Thin Film Transistors) in synchronization with the clock signal.

The gate driver unit 16 receives a clock signal supplied from the timing control unit 14. The gate driver unit 16 supplies a certain scanning signal to the gate of each TFT for a row of sub-pixels on the screen in synchronization with the clock signal through the corresponding one of the gate lines 18 of the TFTs of the liquid crystal panel unit 17.

The liquid crystal panel unit 17 includes an array substrate, a counter substrate opposite the array substrate, and liquid crystal. On the array substrate, TFTs, pixel electrodes connected to the drain electrodes of the TFTs, and counter electrodes (formed of strip electrodes on the counter substrate) are arranged in sets, each of which is arranged at one of intersections between gate lines and data lines to form a pixel, namely, a sub-pixel. Further, the liquid crystal is sealed between the pixel electrodes and the counter electrodes. The liquid crystal panel unit 17 further has, for each pixel, three sub-pixels (not illustrated) corresponding to three-primary RGB colors (Red, Green, and Blue). The liquid crystal panel unit 17 has TFTs having one-to-one correspondence with the sub-pixels. These sub-pixels are connected to the gate lines 18 and the source lines 19 via TFTs (thin-film transistors) that are switching elements thereof.

The gate electrode of a TFT receives a gate signal supplied from the gate driver unit 16, and the TFT is selected and turned on when, for example, the gate signal is at high level. Since the source electrode of a TFT receives a source signal supplied from the source driver unit 15, a gradation voltage appears accordingly across the pixel electrode connected to the drain electrode of the TFT.

The orientation of the liquid crystal changes in accordance with the gradation voltage, and the light transmittance of the liquid crystal changes accordingly. The gradation voltage is held in a liquid crystal capacitor formed by the liquid crystal portion between the pixel electrode connected to the drain electrode of the TFT and the counter electrode, and the orientation of the liquid crystal is maintained. The orientation of the liquid crystal is further maintained until the next signal arrives at the source electrode, resulting in the light transmittance of the liquid crystal being also maintained.

In the way described above, the liquid crystal panel unit 17 displays the supplied video data in gradation. In this embodiment, a transmissive liquid crystal panel has been described. However, this is not meant in a limiting sense, and a reflective liquid crystal panel may also be used.

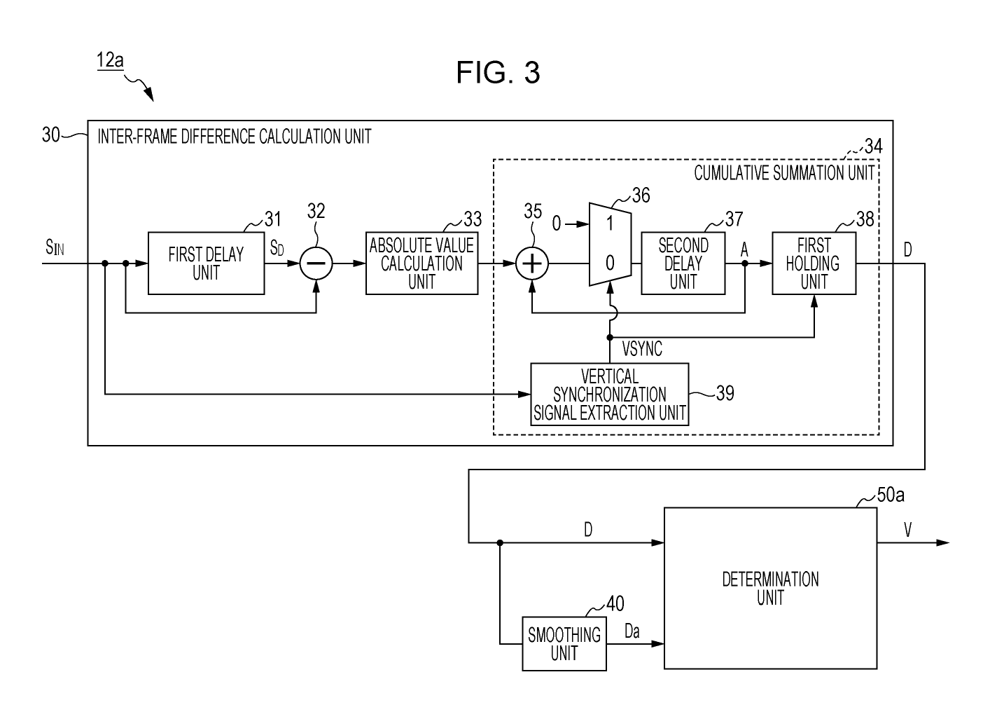

FIG. 3 is a schematic block diagram illustrating a configuration of the scene change detection unit 12a according to the first embodiment. The scene change detection unit 12a includes an inter-frame difference calculation unit 30, a smoothing unit (adjustment unit) 40, and a determination unit 50a. Here, a video signal S_{IN} is composed of a luminance signal and color difference signals. Hereinafter, a process of the scene change detection unit 12a will be described using a luminance signal as an example.

The inter-frame difference calculation unit 30 calculates, for each of the frames constituting the video signal S_{IN} input from the receiving unit 11, a difference between a target frame in which it is to be determined whether or not a scene change has occurred (whether or not the target frame is the first frame after a scene has changed in the video) and the frame immediately preceding the target frame (hereinafter referred to as the immediately preceding frame), that is, differences between pixel values in the target frame and pixel values in the immediately preceding frame corresponding to the positions of the pixel values in the target frame. The inter-frame difference calculation unit 30 calculates the sum of the absolute values of the calculated differences as an inter-frame difference value D, and outputs the calculated inter-frame difference value D to the smoothing unit 40 and the determination unit 50a over a period during which an image signal for the frame subsequent to the target frame is input. In this way, the inter-frame difference calculation unit 30 calculates, based on an image signal, an inter-frame difference value D corresponding to an inter-frame pixel value difference.

That is, the inter-frame difference calculation unit 30 calculates, based on an image signal, an inter-frame difference value D that is a difference between frames in terms of pixel value.

Here, the inter-frame difference calculation unit 30 includes a first delay unit 31 (delay unit), a difference calculation unit 32, an absolute value calculation unit 33, and a cumulative summation unit 34.

The first delay unit 31 delays image signals constituting the video signal S_{IN} input from the receiving unit 11 by one frame. It is assumed here that the image signals have been raster scanned. The first delay unit 31 then supplies a delayed signal S_{D} that is delayed by one frame to the difference calculation unit 32. Here, the delayed signal S_{D} is a signal indicating a pixel value in the immediately preceding frame at the position corresponding to the position of the pixel value in the target frame in which it is to be detected whether or not a scene change has occurred (whether or not the target frame is the first frame after a scene has changed in the video).

The difference calculation unit 32 subtracts a signal indicating the pixel value in the target frame input from the receiving unit 11 from the delayed signal S_{D} input from the first delay unit 31, and supplies a signal indicating the inter-frame pixel value difference obtained by subtraction to the absolute value calculation unit 33.

The absolute value calculation unit 33 calculates the absolute value of the difference indicated by the signal indicating the inter-frame pixel value difference, which is supplied from the difference calculation unit 32, and supplies an absolute value signal indicating the calculated absolute value to the cumulative summation unit 34.

The cumulative summation unit 34 sums absolute values indicated by absolute value signals supplied from the absolute value calculation unit 33 over one frame, and generates an inter-frame difference value D as a result of the summation over one frame. Specifically, the cumulative summation unit 34 sums the absolute value of a difference for each pixel over effective pixels in one frame, and calculates an inter-frame difference value D for each frame. The cumulative summation unit 34 supplies a signal indicating the calculated inter-frame difference value D to the smoothing unit 40 and the determination unit 50a. Further, the cumulative summation unit 34 holds a signal indicating 0.

Here, the cumulative summation unit 34 includes a first summation unit 35, a first selection unit 36, a second delay unit 37, a first holding unit 38, and a vertical synchronization signal extraction unit 39.

The first summation unit 35 sums the absolute value signal supplied from the absolute value calculation unit 33 and a signal indicating a cumulative sum value A, which is input from the second delay unit 37, and supplies the summed signal to the first selection unit 36.

The vertical synchronization signal extraction unit 39 extracts a vertical synchronization signal VSYNC from the video signal S_{IN} supplied from the receiving unit 11, and supplies the extracted vertical synchronization signal VSYNC to the first selection unit 36 and the first first holding unit 38.

The first selection unit 36 supplies summed signals supplied from the first summation unit 35 to the second delay unit 37 for a period during which the vertical synchronization signal VSYNC supplied from the vertical synchronization signal extraction unit 39 indicates 0. Here, the vertical synchronization signal VSYNC is set to 1 for the vertical blanking interval, and otherwise the vertical synchronization signal VSYNC is set to 0. That is, the first selection unit 36 supplies summed signals supplied from the first summation unit 35 to the second delay unit 37 for a period during which image signals in one frame are input.

On the other hand, if the vertical synchronization signal VSYNC with value 1 is supplied to the first selection unit 36 during the vertical blanking interval, the signal indicating 0, which is held in the cumulative summation unit 34, is output to the second delay unit 37. Accordingly, the cumulative sum value A, which is the output value of the second delay unit 37, is reset.

The second delay unit 37 delays a signal supplied from the first selection unit 36 by one pixel clock. The second delay unit 37 then supplies the signal delayed by one pixel clock to the first summation unit 35 and the first holding unit 38 as a signal indicating the cumulative sum value A.

Accordingly, during a non-blanking interval, the first summation unit 35 calculates a cumulative sum by adding together the absolute value of a difference input from the absolute value calculation unit 33 and a cumulative sum value A up to one pixel preceding the current one, which has been input from the second delay unit 37.

During a vertical blanking interval, on the other hand, the first summation unit 35 adds together the absolute value of a difference input from the absolute value calculation unit 33 and 0. Thus, the cumulative sum value A is reset.

Upon detection of a rising edge of the vertical synchronization signal VSYNC supplied from the vertical synchronization signal extraction unit 39 from 0 to 1, the first holding unit 38 outputs an inter-frame difference value D indicating the cumulative sum value A held therein and a signal indicating the inter-frame difference value D to the smoothing unit 40 and the determination unit 50a. The first holding unit 38 outputs a signal indicating the same inter-frame difference value D to the smoothing unit 40 and the determination unit 50a until a rising edge of the subsequent vertical synchronization signal VSYNC from 0 to 1 has been detected. The first holding unit 38 is, for example, a D flip-flop.

The smoothing unit 40 smoothes inter-frame difference values D supplied from the cumulative summation unit 34 over a plurality of frame periods. Specifically, for example, the smoothing unit 40 calculates the average value of inter-frame difference values D for a predetermined number of frames that are immediately preceding frames (for example, eight immediately preceding frames). The smoothing unit 40 outputs a comparative value signal indicating a comparative value Da obtained by smoothing to the determination unit 50a.

In this embodiment, the comparative value Da is an average value of inter-frame difference values D. However, this is not meant in a limiting sense, and the comparative value Da may be an intermediate value of inter-frame difference values. Alternatively, the smoothing unit 40 may calculate a comparative value Da by applying a low-pass filter to inter-frame difference values D for a predetermined number of frames.

In this embodiment, furthermore, the smoothing unit 40 calculates a comparative value by using inter-frame difference values D for a predetermined number of frames that are immediately preceding frames (for example, eight frames). However, this is not meant in a limiting sense, and the smoothing unit 40 may calculate a comparative value by using inter-frame difference values D for frames other than several frames immediately preceding the target frame. In this way, the smoothing unit 40 may calculate a comparative value by adjusting the value of an inter-frame difference value D of the target frame in accordance with inter-frame difference values D of non-target frames.

That is, the comparative value may be a value that is based on an inter-frame difference value D for frames other than the target frame. For example, the comparative value may be a value that is based on an inter-frame difference value D for neighboring frames of the target frame. Alternatively, the comparative value may be a value that is based on an inter-frame difference value D of a series of frames adjacent to the target frame. The comparative value may also be a value that is based on an inter-frame difference value D of frames subsequent to the target frame. The comparative value may also be a value that is based on inter-frame difference values D of the frames preceding and subsequent to the target frame.

The determination unit 50a refers to the signal indicating the inter-frame difference value D supplied from the cumulative summation unit 34 of the inter-frame difference calculation unit 30 and the signal indicating the comparative value Da supplied from the smoothing unit 40, and determines whether or not a scene change has occurred in the target frame (whether or not the first frame after a scene has changed in the video). Then, the determination unit 50a supplies a scene change signal V indicating a determination result to the video storage processing unit 21. In this way, the determination unit 50a refers to a first value that is an inter-frame pixel value difference between a target frame and a frame other than the target frame, and a comparative value derived from a second value that is an inter-frame pixel value difference between frames other than the target frame, and determines whether or not the target frame is the first frame after a scene has changed in the video.

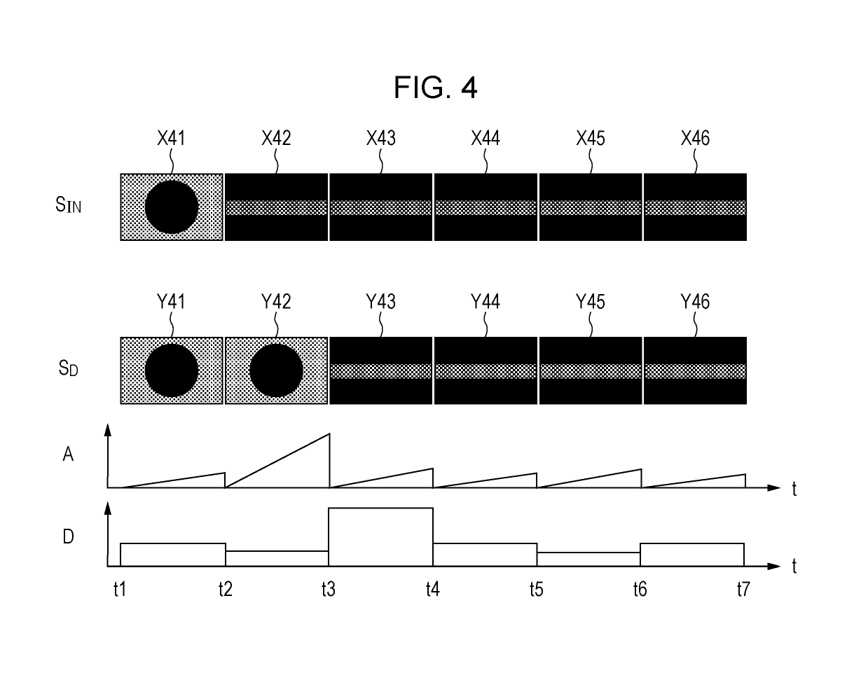

FIG. 4 is a diagram depicting a calculation process for an inter-frame difference value D. In FIG. 4, images X41 to X46 indicated by the video signal S_{IN} input to the first delay unit 31, which are original images, are illustrated with the passage of time t in the first row from the top. In FIG. 4, furthermore, images Y41 to Y46 indicated by the delayed signal S_{D} output from the first delay unit 31 in a case where the image signal indicating the images in the first row is input to the first delay unit 31 are illustrated with the passage of time t in the second row from the top. Here, it is shown that the images in the second row from the top in FIG. 4 are delayed by one frame with respect to the images in the first row.

In FIG. 4, furthermore, the third row from the top illustrates the cumulative sum value A in the cumulative summation unit 34 that changes with time in a case where the image signal indicating the images in the first row from the top in FIG. 4 is input from the first delay unit 31 and the delayed signal S_{D} indicating the images in the second row from the top in FIG. 4 is output from the first delay unit 31. Here, the cumulative sum value A monotonically increases with time, and is reset to 0 at the end of the input of image signals for one frame to the first delay unit 31.

In FIG. 4, furthermore, the fourth row from the top illustrates an inter-frame difference value D output from the cumulative summation unit 34 which changes with time in a case where the cumulative sum value A changes with time in the manner illustrated in the third row from the top in FIG. 4. Here, the inter-frame difference value D indicates the same value for each frame, which is equal to an image cumulative sum value A at the time immediately before the beginning of the target frame. For example, the inter-frame difference value D from time t3 to time t4 is equal to the cumulative sum value A at the time immediately before the time t3.

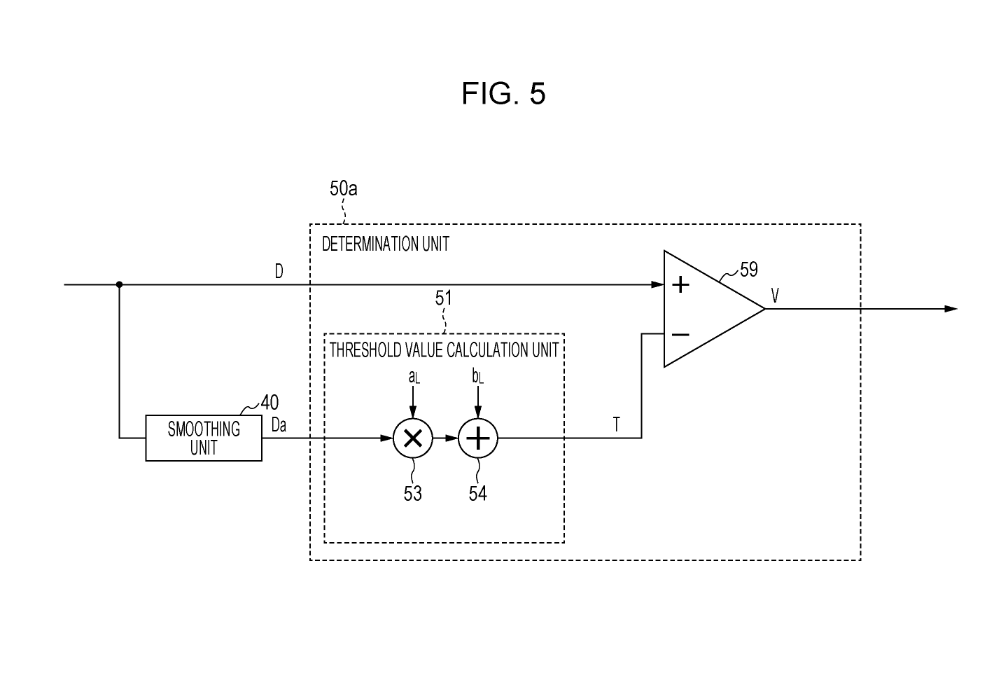

FIG. 5 is a schematic block diagram of the determination unit 50a according to the first embodiment. The determination unit 50a includes a threshold value calculation unit 51 and a comparison unit 59.

The threshold value calculation unit 51 calculates a threshold value T in accordance with the comparative value Da indicated by the comparative value signal supplied from the smoothing unit 40, and supplies a threshold value signal indicating the calculated threshold value T to the comparison unit 59.

Here, the threshold value calculation unit 51 includes a first multiplication unit 53 and a second summation unit 54. The first multiplication unit 53 multiplies the comparative value Da indicated by the comparative value signal supplied from the smoothing unit 40 by a predetermined gradient a_{L}, and supplies a signal indicating the value obtained by multiplication to the second summation unit 54.

The second summation unit 54 adds an intercept b_{L} to the signal indicating the value obtained by multiplication, which is supplied from the first multiplication unit 53, and supplies a signal obtained by addition to the comparison unit 59 as a threshold value signal indicating a threshold value.

The comparison unit 59 compares the signal indicating the inter-frame difference value D supplied from the cumulative summation unit 34 of the inter-frame difference calculation unit 30 with the threshold value signal supplied from the second summation unit 54 of the threshold value calculation unit 51. If the inter-frame difference value D is larger than the threshold value indicated by the threshold value signal, the comparison unit 59 sets the value of the scene change signal V to 1, and supplies the scene change signal V to the video storage processing unit 21. In other words, if the inter-frame difference value D is larger than the threshold value indicated by the threshold value signal, the comparison unit 59 determines that a scene change has occurred in the target frame, or determines that the target frame is the first frame after a scene has changed in the video.

On the other hand, if the inter-frame difference value D is less than or equal to the threshold value indicated by the threshold value signal, the comparison unit 59 sets the value of the scene change signal V to 0, and supplies the scene change signal V to the video storage processing unit 21. In other words, if the inter-frame difference value D is less than or equal to the threshold value indicated by the threshold value signal, the comparison unit 59 determines that no scene changes have occurred in the target frame.

Accordingly, the comparison unit 59 determines, based on the comparison between the inter-frame difference value D calculated by the inter-frame difference calculation unit 30 and the threshold value calculated by the threshold value calculation unit 51, whether or not a scene change has occurred in the target frame, that is, whether or not the target frame is the first frame after a scene has changed in the video.

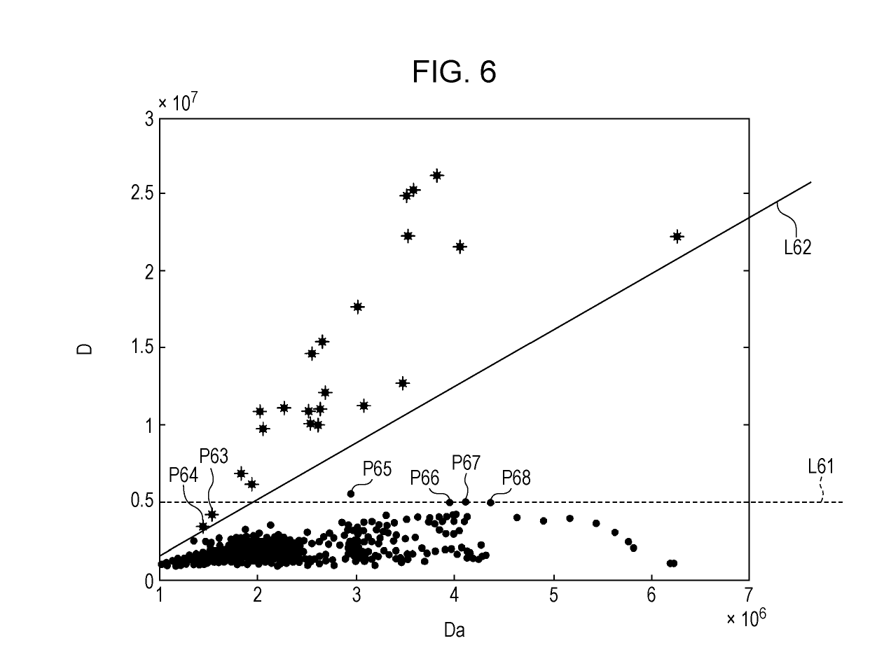

Next, a process of the determination unit 50a according to the first embodiment will be described with reference to FIGS. 6 to 8. FIG. 6 is a diagram illustrating an example of the relationship between the inter-frame difference value D and the comparative value Da. In FIG. 6, the vertical axis represents inter-frame difference values D, and the horizontal axis represents comparative values Da. In FIG. 6, a black circle mark indicates an inter-frame difference value D when no scene changes have occurred, and an asterisk mark indicates an inter-frame difference value D when an actual scene change has occurred. FIG. 6 illustrates a straight line L61 indicating an existing threshold value, and a straight line L62 indicating a threshold value T of this embodiment. Here, the straight line L62 has gradient a and intercept b, and is represented by T=a×Da+b.

As indicated by the straight line L61 indicating an existing threshold value, the existing threshold value is constant regardless of the comparative value Da. For this reason, if the comparative value Da is small, in some cases, an inter-frame difference value D when a scene change has occurred may be less than or equal to the existing threshold value (for example, a point P63 and a point P64). In such cases, an existing device fails to detect a scene change even though a scene change has actually occurred. Further, if the comparative value Da is approximately intermediate, in some cases, an inter-frame difference value D when no scene changes have occurred may exceed the existing threshold value (for example, point P65 to point P67). In such cases, an existing device erroneously detects that a scene change has occurred (the frame in question is the first frame after a scene has changed in the video) although a scene change has not actually occurred.

In contrast, as indicated by the straight line L62 indicating the threshold value T of this embodiment, the threshold value T increases linearly as the comparative value Da increases. In FIG. 6, it is shown that an inter-frame difference value D when a scene change has occurred exceeds the threshold value T. It is also found that an inter-frame difference value D when no scene changes have occurred is less than or equal to the threshold value T.

In this manner, the threshold value calculation unit 51 of this embodiment causes the threshold value T to vary in accordance with the comparative value Da. Specifically, for example, the threshold value calculation unit 51 calculates a threshold value T so that the threshold value T increases as the comparative value Da increases. Accordingly, the determination unit 50a can determine whether or not a scene change has occurred in the target frame (whether or not the target frame is the first frame after a scene has changed in the video) with higher accuracy than existing devices.

In this embodiment, the threshold value calculation unit 51 causes the threshold value T to increase linearly in accordance with the comparative value Da. However, this is not meant in a limiting sense, and the threshold value T may be caused to increase non-linearly.

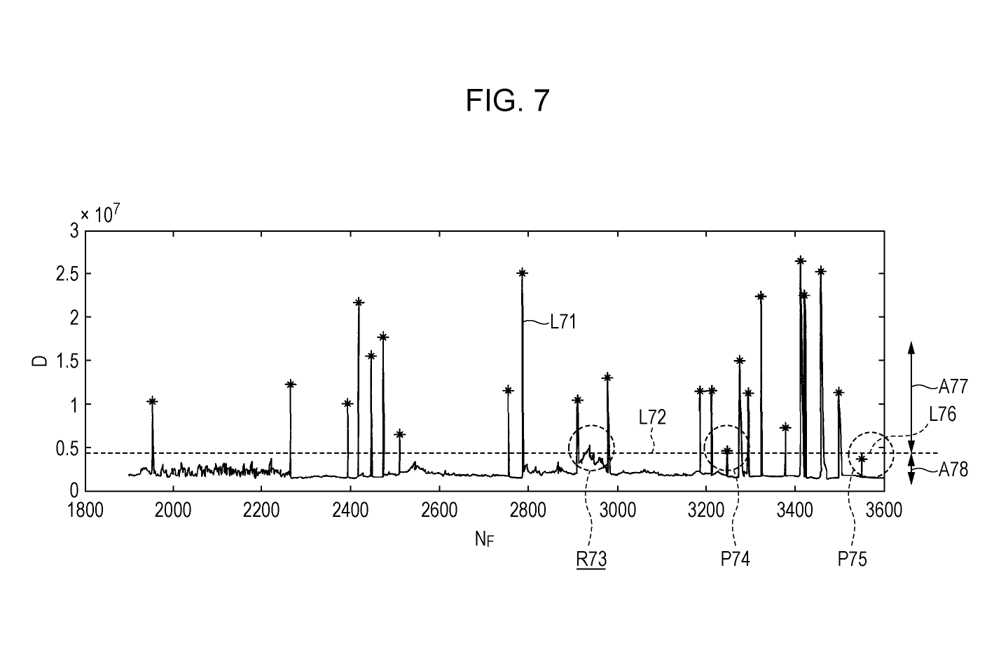

FIG. 7 is a diagram depicting an issue raised in the description of determination using an existing threshold value. In FIG. 7, the vertical axis represents inter-frame difference values D, and the horizontal axis represents frame numbers N_{F}. The horizontal axis represents frame numbers N_{F}, and is thus equivalent to time. FIG. 7 illustrates a curved line L71 indicating a frame change of the inter-frame difference value D, and a straight line L72 indicating an existing threshold value. In addition, an asterisk mark indicates an inter-frame difference value D when an actual scene change has occurred.

In FIG. 7, a straight line L76 indicating an existing threshold value for the inter-frame difference value D is illustrated. A range A77 in which the inter-frame difference value D is larger than the existing threshold value indicated by the straight line L76 is a range where it is determined that a scene change exists. A range A78 in which the inter-frame difference value D is less than or equal to the existing threshold value indicated by the straight line L76 is a range where it is determined that a scene change does not exist.

For frames in a region R73, it is determined that a scene change has occurred although these frames are actually in a panning scene, because the inter-frame difference values D exceed the threshold value.

For a frame at point P74 and a frame at point P75, it is determined that no scene changes have occurred although scene changes have actually occurred, because the inter-frame difference values D are less than or equal to the threshold value.

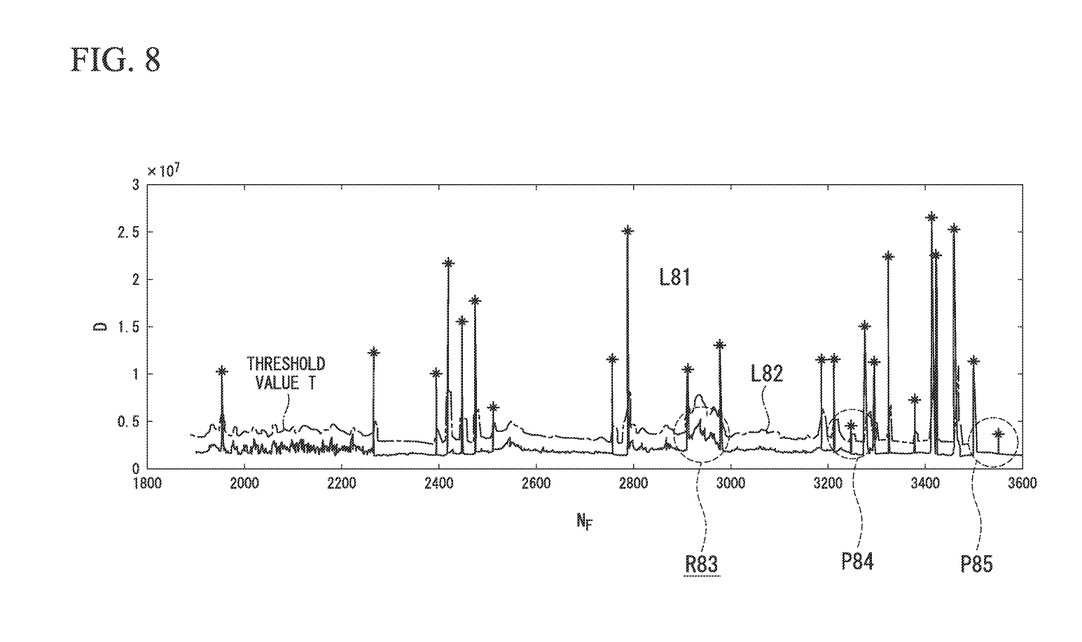

FIG. 8 is a diagram depicting determination using a threshold value T according to this embodiment. In FIG. 8, the vertical axis represents inter-frame difference values D, and the horizontal axis represents frame numbers N_{F}. The horizontal axis represents frame numbers N_{F}, and is thus equivalent to time. FIG. 8 illustrates a curved line L81 indicating a change of the inter-frame difference value D for each frame, and a curved line L82 indicating the threshold value T. In addition, an asterisk mark indicates an inter-frame difference value D when an actual scene change has occurred.

In FIG. 8, it is shown that all the inter-frame difference values D when a scene change has occurred exceed the threshold value T.

The determination unit 50a can determine that no scene changes have occurred in frames in a region R83, which are actually frames in a panning scene, since the inter-frame difference values D are less than or equal to the threshold value T.

The determination unit 50a can determine that a scene change has occurred in a frame at point P84 and a frame at point P85, in which a frame change has actually occurred, since the inter-frame difference values D exceed the threshold value T.

In this way, in the related art, since a fixed threshold value is used regardless of the value of an inter-frame difference value D, it is difficult to distinguish a panning scene from a scene change when the inter-frame difference value D is small. In contrast, the determination unit 50a of this embodiment causes a threshold value to vary in accordance with the value of the inter-frame difference value D, allowing a panning scene and a scene change to be distinguished from each other when the inter-frame difference value D is small. Accordingly, the determination unit 50a can determine whether or not a scene change has occurred in the target frame with higher accuracy than existing devices.

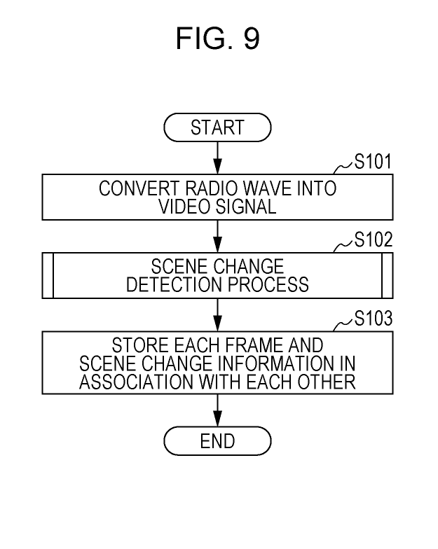

FIG. 9 is a flowchart illustrating an example of the flow of a video saving process of the display device 10a according to the first embodiment. First, the receiving unit 11 receives a radio wave from an antenna. The receiving unit 11 converts the received radio wave into a video signal (step S101). The receiving unit 11 supplies the converted video signal to the scene change detection unit 12a and the video storage processing unit 21. The scene change detection unit 12a determines, based on the video signal supplied from the receiving unit 11, whether or not a scene change has occurred in the target frame (whether or not the target frame is the first frame in a video scene that has changed) (step S102). The scene change detection unit 12a supplies a scene change signal V indicating a determination result to the video storage processing unit 21.

The video storage processing unit 21 causes the storage unit 22 to store, in accordance with the scene change signal V supplied from the scene change detection unit 12a and the video signal S_{IN} supplied from the receiving unit 11, each of the frames constituting the video signal S_{IN} and scene change information indicating whether or not a scene change has occurred in the frame in question, in association with each other (step S103). Then, the process of this flowchart ends.

Accordingly, the display device 10a determines, for each frame of a received video signal, whether or not a target frame to be subjected to determination is a scene change, and stores scene change information indicating a determination result and the image of the target frame in association with each other. Thus, the display device 10a can refer to the stored scene change information to reproduce a video signal on a scene-by-scene basis. In addition, in order to skip to the next scene during the reproduction of the video, the display device 10a of this embodiment reads and displays video associated with the scene change information on the scene subsequent to the currently reproduced scene, enabling skipping from one scene to the next in the video. Similarly, in order to skip to the preceding scene during the reproduction of the video, the display device 10a reads and displays video associated with the scene change information on the scene preceding the currently reproduced scene, enabling rewinding back from one scene to the previous in the video.

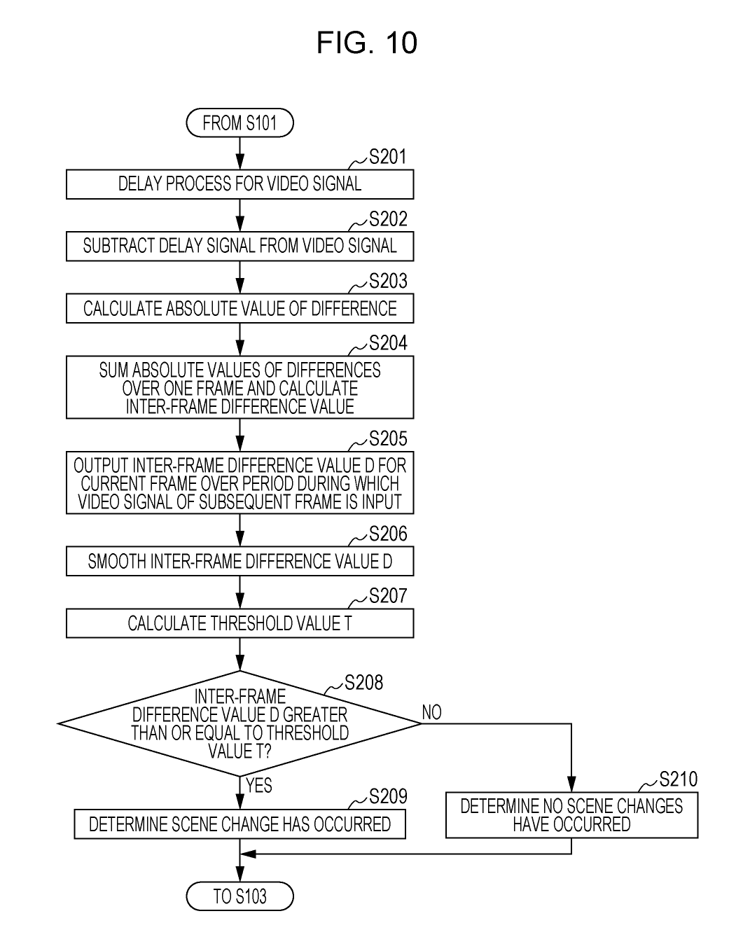

FIG. 10 is a flowchart illustrating an example of the flow of the scene change detection process in step S102 in FIG. 9. First, the first delay unit 31 delays the video signal S_{IN}, and generates a delayed signal S_{D} (step S201). Then, the difference calculation unit 32 substrates the delayed signal from the video signal S_{IN} to determine a difference between them (step S202). Then, the absolute value calculation unit 33 calculates the absolute value of the difference (step S203). Then, the cumulative summation unit 34 sums the absolute values of differences over one frame to calculate an inter-frame difference value D (step S204). Then, the cumulative summation unit 34 outputs a signal indicating the inter-frame difference value D of the target frame over a period during which a video signal for the frame subsequent to the target frame is input (step S205).

Then, by way of example, the smoothing unit 40 smoothes the inter-frame difference values D over several nearest neighboring frames to calculate a comparative value Da (step S206). Then, the determination unit 50a calculates a threshold value T based on the comparative value Da (step S207). Then, the determination unit 50a determines whether or not the inter-frame difference value D is greater than or equal to the threshold value T (step S208). If the inter-frame difference value D is greater than or equal to the threshold value T (YES in step S208), the determination unit 50a determines that a scene change exists (step S209), and supplies the scene change signal V with value 1 to the video storage processing unit 21. If the inter-frame difference value D is less than the threshold value T (NO in step S208), the determination unit 50a determines that a scene change does not exist (step S210), and supplies the scene change signal V with value 0 to the video storage processing unit 21. Then, the process of this flowchart ends.

Accordingly, by way of example, the scene change detection unit 12a smoothes inter-frame difference values D over several nearest neighboring frames to calculate a comparative value Da, and calculates a threshold value T based on the comparative value Da. Thus, the threshold value T varies in accordance with the several nearest neighboring frames of the target frame. In a scene change with an abrupt change in the inter-frame difference value D with time, the comparative value Da, which is an average of inter-frame difference values D of several nearest neighboring frames, is sufficiently smaller than the inter-frame difference value D of a scene-change frame. Thus, the determination unit 50a calculates a threshold value T as a value smaller than an inter-frame difference value D for a scene change. Accordingly, an inter-frame difference value D for a scene change is greater than or equal to the threshold value T, allowing the determination unit 50a to detect a scene change with high accuracy.

On the other hand, in a panning scene with a moderate increase in the inter-frame difference value D with time, the comparative value Da, which is an average of inter-frame difference values D of several nearest neighboring frames, tends to be larger than the comparative value Da, which is the average of inter-frame difference values D of several nearest neighboring frames of a scene-change frame. Thus, the determination unit 50a calculates a threshold value T for panning as a value larger than an inter-frame difference value D for a panning scene. Accordingly, an inter-frame difference value D for a panning scene is less than the threshold value T, preventing the determination unit 50a from erroneously detecting a panning scene as a scene change. Scene changes can thus be detected with high accuracy.

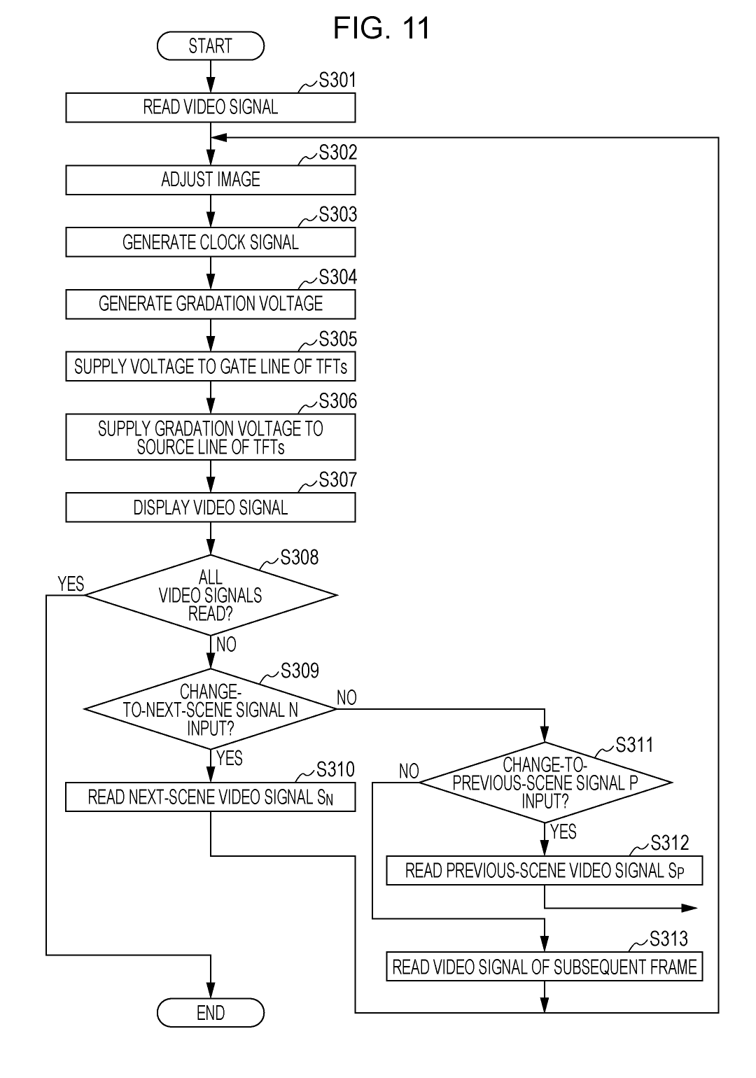

FIG. 11 is a flowchart illustrating an example of the flow of a reproduction process of the display device 10a according to the first embodiment. First, the video changing unit 24 reads a video signal from the storage unit 22, and supplies the read video signal to the image adjustment unit 13 (step S301). Then, the image adjustment unit 13 receives a noise-reduced luminance signal supplied from the video changing unit 24. The image adjustment unit 13 performs I/P conversion on the noise-reduced luminance signal (conversion from an interlaced signal to a progressive signal) (step S302). The image adjustment unit 13 adjusts the number of pixels of the I/P converted signal. The image adjustment unit 13 supplies the adjusted signal for which the number of pixels has been adjusted to the timing control unit 14 and the source driver unit 15.

Then, the timing control unit 14 receives the adjusted signal supplied from the image adjustment unit 13. The timing control unit 14 generates a clock signal for distributing the adjusted signal over the pixels on the plane (step S303). The timing control unit 14 supplies the generated clock signal to the source driver unit 15 and the gate driver unit 16.

Then, the source driver unit 15 generates a gradation voltage for driving liquid crystal from the adjusted signal (step S304). The source driver unit 15 holds the gradation voltage in an internal hold circuit for each source line.

Then, the gate driver unit 16 supplies a predetermined voltage to a gate line of a TFT of the liquid crystal panel unit 17 (step S305).

Then, the source driver unit 15 supplies the gradation voltage to a source line of TFTs of the liquid crystal panel unit 17 for a vertical array on the screen in synchronization with the clock signal (step S306).

Thus, video data is sequentially supplied to the source line for a period of time during which each gate line is selected, and necessary data is written to the pixel electrodes through the TFTs. Accordingly, the pixel electrodes change the corresponding liquid crystal transmittance in accordance with the voltage for the pixel electrodes. Consequently, the liquid crystal panel unit 17 displays a video signal (step S307).

Then, the video changing unit 24 determines whether or not all the video signals have been read (step S308). If it is determined that not all the video signals have been read (NO in step S308), the video changing unit 24 determines whether or not a change-to-next-scene signal N has been input to the input unit 23 (step S309). If a change-to-next-scene signal N has been input (YES in step S309), the video changing unit 24 reads a next-scene video signal S_{N} from the storage unit 22 (step S310), and supplies the read next-scene video signal S_{N} to the image adjustment unit 13. Then, the process returns to step S302.

On the other hand, if it is determined that a change-to-next-scene signal N has not been input (NO in step S309), the video changing unit 24 determines whether or not a change-to-previous-scene signal P has been input from the input unit 23 (step S311). If the video changing unit 24 determines that a change-to-previous-scene signal P has been input (YES in step S311), the video changing unit 24 reads a previous-scene video signal S_{P} from the storage unit 22 (step S312), and supplies the read previous-scene video signal S_{P} to the image adjustment unit 13. Then, the process returns to step S302.

If it is determined that a change-to-previous-scene signal P has not been input (NO in step S311), the video changing unit 24 reads the video signal of the subsequent frame from the storage unit 22 (step S313), and supplies the video signal of the read subsequent frame to the image adjustment unit 13. Then, the process returns to step S302. If the video changing unit 24 determines in step S308 that all the video signals have been read (YES in step S308), the display device 10a causes the process of this flowchart to end.

As described above, during the reproduction of video, the display device 10a of this embodiment reads and displays video associated with scene change information indicating a scene change from the currently reproduced scene to the next scene, enabling skipping from one scene to the next in the video. Similarly, the display device 10a reads and displays video associated with scene change information indicating a scene change to the scene preceding the currently reproduced scene, enabling rewinding back from one scene to the previous in the video.

### Second Embodiment

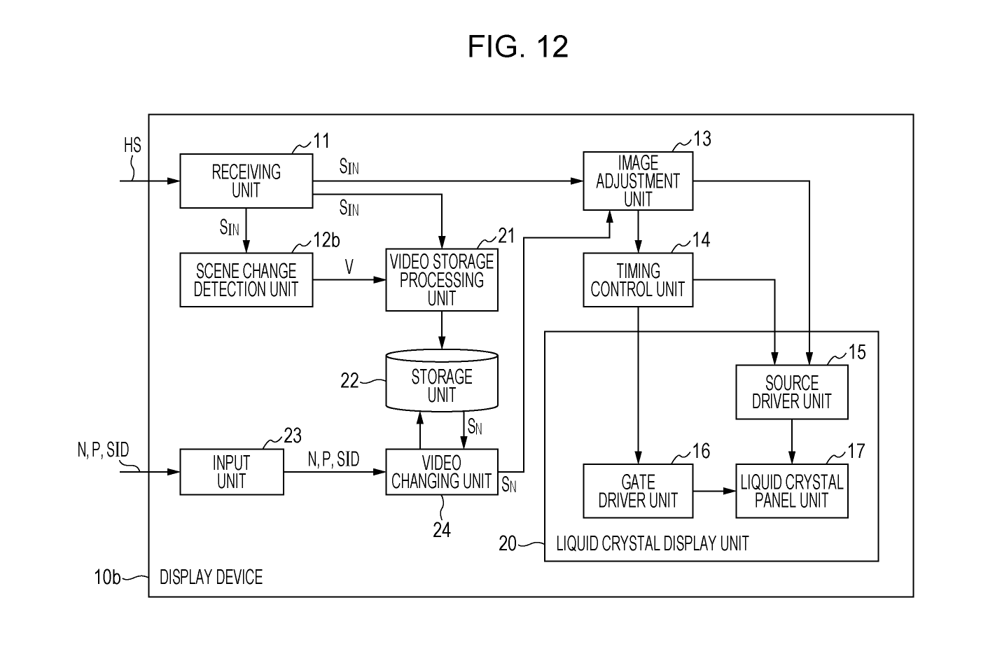

Next, a second embodiment of the present invention will be described. FIG. 12 is a schematic block diagram of a display device 10b according to the second embodiment. Elements common to those in FIG. 1 are assigned the same numerals, and will not be described in detail herein.

The configuration of the display device 10b in FIG. 12 is different from the configuration of the display device 10a in FIG. 1 in that the scene change detection unit 12a is replaced with a scene change detection unit 12b.

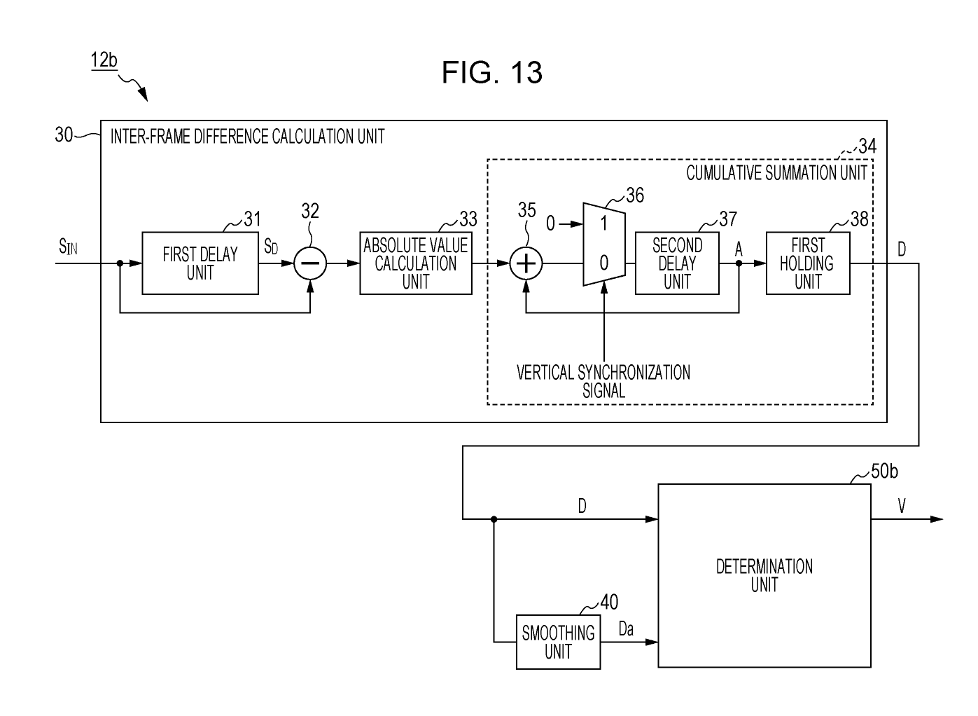

FIG. 13 is a schematic block diagram of the scene change detection unit 12b according to the second embodiment. Elements common to those in FIG. 3 are assigned the same numerals, and will not be described in detail herein.

The configuration of the scene change detection unit 12b in FIG. 13 is different from the configuration of the scene change detection unit 12a in FIG. 3 in that the determination unit 50a is replaced with a determination unit 50b.

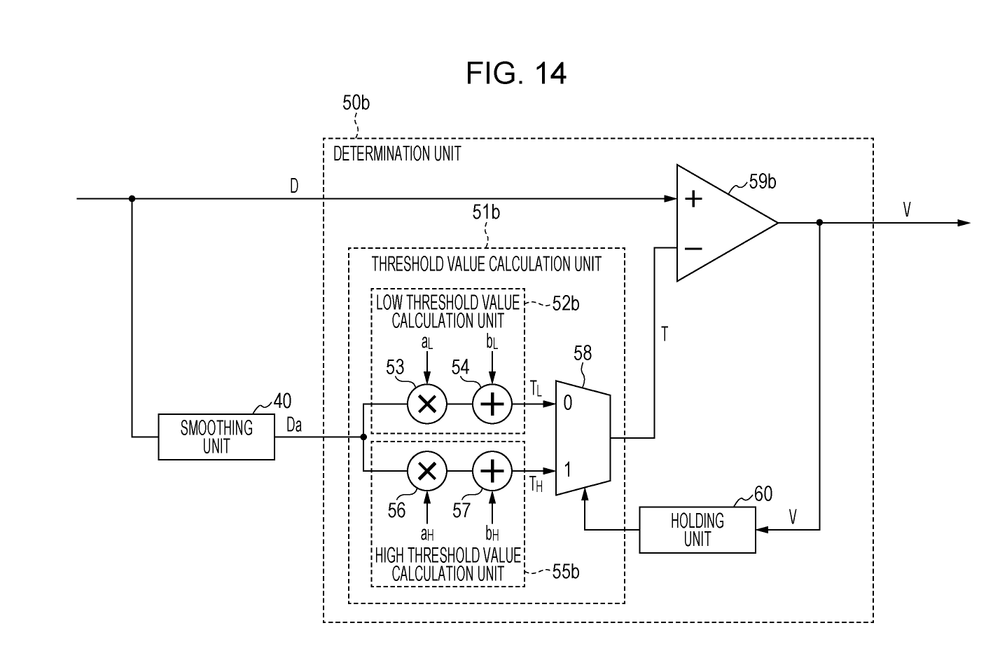

FIG. 14 is a schematic block diagram of the determination unit 50b according to the second embodiment. Elements common to those in FIG. 5 are assigned the same numerals, and will not be described in detail herein. The configuration of the determination unit 50b in FIG. 13 is different from the configuration of the determination unit 50a in FIG. 5 in that the threshold value calculation unit 51 is replaced with a threshold value calculation unit 51b, the comparison unit 59 is replaced with a comparison unit 59b, and a second holding unit 60 is additionally included.

Here, the threshold value calculation unit 51b calculates a threshold value T in accordance with a signal indicating the comparative value Da supplied from the smoothing unit 40, and supplies a signal indicating the calculated threshold value T to the comparison unit 59b.

The threshold value calculation unit 51b includes a low threshold value calculation unit 52b, a high threshold value calculation unit 55b, and a second selection unit (selection unit) 58.

The low threshold value calculation unit 52b calculates a low threshold value T_{L} based on a comparative value Da indicated by the signal indicating the comparative value Da supplied from the smoothing unit 40, and supplies a signal indicating the calculated low threshold value T_{L} to the second selection unit 58.

Here, the low threshold value calculation unit 52b includes a first multiplication unit 53 and a second summation unit 54. The first multiplication unit 53 multiplies the signal indicating the comparative value Da supplied from the smoothing unit 40 by a signal indicating a predetermined gradient a_{L}, and supplies the signal obtained by multiplication to the second summation unit 54.

The second summation unit 54 adds a signal indicating a predetermined intercept b_{L} to the signal obtained by multiplication, which is supplied from the first multiplication unit 53, and supplies the summed signal to the second selection unit 58 as a signal indicating the low threshold value T_{L}. Here, the low threshold value T_{L}, is represented by a_{L}×Da+b_{L}.

The high threshold value calculation unit 55b calculates, based on the comparative value Da, a high threshold value T_{H} larger than the low threshold value T_{L} calculated by the low threshold value calculation unit 52b based on the comparative value Da, and supplies a signal indicating the calculated high threshold value T_{H} to the second selection unit 58.

Here, the high threshold value calculation unit 55b includes a second multiplication unit 56 and a third summation unit 57. The second multiplication unit 56 multiplies the signal indicating the comparative value Da supplied from the smoothing unit 40 by a signal indicating a predetermined gradient a_{H} (where a_{H} is greater than or equal to a_{L}), and supplies the signal obtained by multiplication to the third summation unit 57.

The third summation unit 57 adds a signal indicating a predetermined intercept b_{H} (where b_{H} is greater than or equal to b_{L}) to the signal obtained by multiplication, which is supplied from the second multiplication unit 56, and supplies the summed signal to the second selection unit 58 as a signal indicating the high threshold value T_{H}. Here, the high threshold value T_{H} is represented by a_{H}×Da+b_{H}.

The second selection unit 58 selects one of the low threshold value T_{L} and the high threshold value T_{H} as a threshold value T in accordance with a result of determination by the comparison unit 59b as to whether or not a scene change has occurred in the immediately preceding frame (whether or not the immediately preceding frame is the first frame in a video scene that has changed). Specifically, the second selection unit 58 receives, from the second holding unit 60, a signal indicating a result of determination by the comparison unit 59b as to whether or not a scene change has occurred in the immediately preceding frame (whether or not the immediately preceding frame is the first frame in a video scene that has changed). If the signal received from the second holding unit 60 indicates a scene change has occurred (for example, if the signal indicates 1), the second selection unit 58 selects the high threshold value T_{H} as the threshold value T. On the other hand, if the signal received from the second holding unit 60 indicates that no scene changes have occurred (for example, if the signal indicates 0), the second selection unit 58 selects the low threshold value T_{L} as the threshold value T.

In this manner, if the determination unit 50b determines that the target frame is the first frame in a video scene that has changed, the threshold value calculation unit 51b sets the threshold value for the frame subsequent to the target frame to be higher than the threshold value that is based on the comparative value for the frame subsequent to the target frame. On the other hand, if the determination unit 50b determines that the target frame is not the first frame in a video scene that has changed, the threshold value calculation unit 51b sets the threshold value for the frame subsequent to the target frame to be equal to the threshold value that is based on the comparative value for the frame subsequent to the target frame.

That is, if the comparison unit 59b determines that a scene change has occurred in the frame immediately preceding the target frame, the second selection unit 58 selects the high threshold value T_{H} as the threshold value T. If the comparison unit 59b determines that no scene changes have occurred in the frame immediately preceding the target frame, the second selection unit 58 selects the low threshold value T_{L} as the threshold value T.

Then, the second selection unit 58 supplies a signal indicating the selected threshold value T to the comparison unit 59b.

Accordingly, the second selection unit 58 causes the threshold value T to increase in a case where it is determined that a scene change has occurred in the frame immediately preceding the target frame in which it is to be determined whether or not a scene change has occurred (whether or not the target frame is the first frame in a video scene that has changed). By increasing the threshold value T immediately after a scene change, the determination unit 50b can prevent a panning scene from being erroneously detected as a scene change if the panning scene begins immediately after the scene change. Scene changes can thus be detected with high accuracy.

The comparison unit 59b determines, based on the signal indicating the inter-frame difference value D supplied from the cumulative summation unit 34 and the threshold value T supplied from the threshold value calculation unit 51b, whether or not a scene change has occurred in the target frame corresponding to the inter-frame difference value D (whether or not the target frame is the first frame in a video scene that has changed).

Specifically, for example, the comparison unit 59b sets the value of the scene change signal V to 1 if the inter-frame difference value D is greater than or equal to the threshold value T. Here, the scene change signal V with value 1 indicates that a scene change has occurred in the target frame. Thus, if the inter-frame difference value D is greater than or equal to the threshold value T, the comparison unit 59b determines, as a result of the process described above, that a scene change has occurred in the target frame.

On the other hand, if the inter-frame difference value D is less than the threshold value T, the comparison unit 59b sets the value of the scene change signal V to 0. Here, the scene change signal V with value 0 indicates that no scene changes have occurred in the target frame. Thus, if the inter-frame difference value D is less than the threshold value T, the comparison unit 59b determines, as a result of the process described above, that no scene changes have occurred in the target frame.

The comparison unit 59b supplies the scene change signal V to the second holding unit 60 and the video storage processing unit 21.

The second holding unit 60 loads the scene change signal V supplied from the comparison unit 59b at a rising edge of a clock signal (not illustrated), and supplies the loaded scene change signal V to the second selection unit 58. The second holding unit 60 supplies the loaded scene change signal V to the second selection unit 58 until the next rising edge of the clock signal. The second holding unit 60 is, for example, a D flip-flop.

Accordingly, the second holding unit 60 supplies the scene change signal V for the target frame to the second selection unit 58 for a process for calculating the threshold value T for the frame subsequent to the target frame. As a result, if the scene change signal V of target frame indicates 1, that is, if a scene change has occurred in the target frame, the second selection unit 58 can select the high threshold value T_{H} as the threshold value T for the frame subsequent to the target frame. Further, if the scene change signal V of the target frame indicates 0, that is, if no scene changes have occurred in the target frame, the second selection unit 58 can select the low threshold value T_{L} as the threshold value T for the frame subsequent to the target frame.

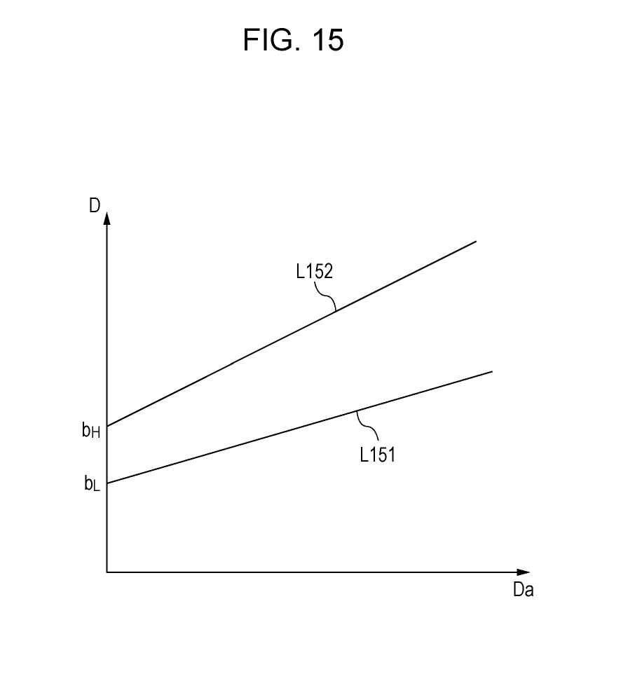

The relationship between the high threshold value T_{H} and the low threshold value T_{L} will now be described with reference to FIG. 15. FIG. 15 is a diagram illustrating the relationship between the high threshold value T_{H} and the comparative value Da and between the low threshold value T_{L} and the comparative value Da. In FIG. 15, the vertical axis represents inter-frame difference values D, and the horizontal axis represents comparative values Da. FIG. 15 illustrates a straight line L151 indicating the low threshold value T_{L} and a straight line L152 indicating the high threshold value T_{H}. In FIG. 15, it is shown that in a case where the comparative value Da is a value greater than or equal to 0, the high threshold value T_{H} is always greater than or equal to the low threshold value T_{L} for an equal comparative value Da.

Accordingly, regardless of which value among the values greater than or equal to 0 the comparative value Da is, the threshold value calculation unit 51b can set the threshold value T used for the determination of the frame immediately after a scene change to be higher than that in the first embodiment. As a result, if the frame immediately after a scene change is in a panning scene, the panning scene can be prevented from being erroneously detected as a scene change. In addition, the gradient a_{H} and the intercept b_{H} are set so that the high threshold value T_{H} becomes equal to an appropriate value without excessively increasing. Accordingly, if a scene change occurs again in a frame immediately after a scene change, the inter-frame difference value D for the frame immediately after the second scene change can be set to be greater than or equal to the high threshold value T_{H}. The determination unit 50b can thus accurately determine the occurrence of the scene change.

That is, the scene change detection unit 12b of the second embodiment can detect each of consecutive scene changes as a scene change while preventing a panning scene immediately after a scene change from being erroneously detected as a scene change. The scene change detection unit 12b can thus detect scene changes with higher accuracy than the scene change detection unit 12a of the first embodiment.

In this embodiment, the low threshold value calculation unit 52b applies the comparative value Da to a linear function to calculate a low threshold value T_{L}. However, this is not meant in a limiting sense, and the low threshold value calculation unit 52b may apply the comparative value Da to a predetermined first function (for example, a quadratic or higher function of the comparative value Da) to calculate a low threshold value T_{L}.

In this embodiment, furthermore, the high threshold value calculation unit 55b applies the comparative value Da to a linear function to calculate a high threshold value T_{H}. However, this is not meant in a limiting sense, and the high threshold value calculation unit 55b may apply the comparative value Da to a predetermined second function (for example, a quadratic or higher function of the comparative value Da) to calculate a high threshold value T_{H}.

In this case, in a case where the comparative value Da is a value greater than or equal to 0, the return value of the second function described above may only be required to be greater than or equal to the return value of the first function for an equal comparative value Da.

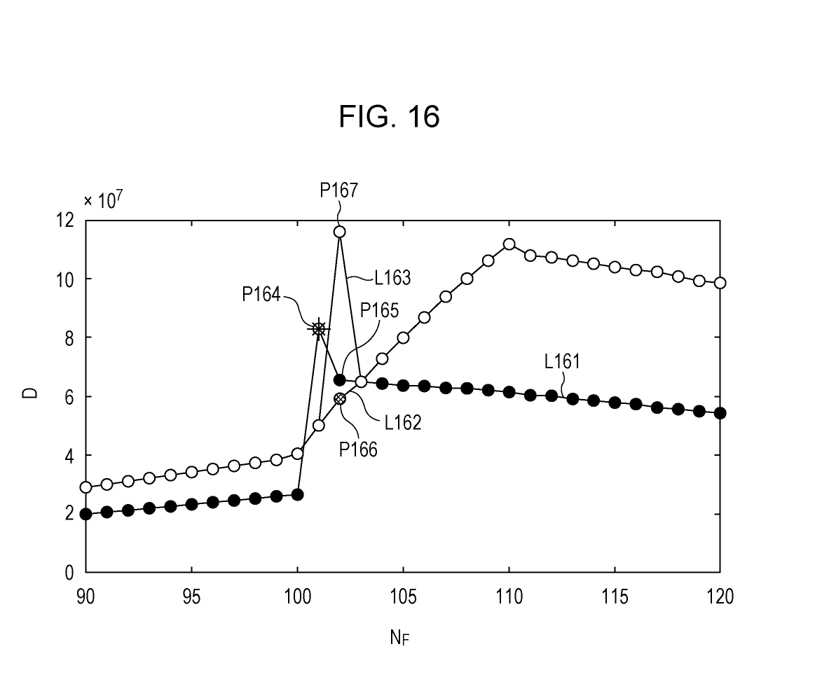

Next, advantages of the process of the threshold value calculation unit 51b of the second embodiment in a case where a panning scene begins immediately after a scene change will be described with reference to FIG. 16. FIG. 16 is a diagram illustrating an example of the relationship among the inter-frame difference value D, the threshold value T, and the number of frames in a case where a panning scene begins immediately after a scene change. In FIG. 16, the vertical axis represents inter-frame difference values D, and the horizontal axis represents frame numbers N_{F}. FIG. 16 illustrates a line L161 of the inter-frame difference value D, a line L162 of the threshold value T of the first embodiment, a line L163 of the threshold value T of the second embodiment, a point P164 indicating the inter-frame difference value D for a scene-change frame, a point P165 indicating the inter-frame difference value D for a frame immediately after a scene change, a point P166 indicating the threshold value T of the first embodiment for a frame immediately after a scene change, and a point P167 indicating the threshold value T of the second embodiment for a frame immediately after a scene change.

The inter-frame difference value D for a frame immediately after a scene change, which is indicated by the point P165, is greater than or equal to the threshold value T of the first embodiment for a frame immediately after a scene change, which is indicated by the point P166. This may cause the determination unit 50a of the first embodiment to erroneously detect that a scene change has occurred in the frame immediately after the scene change.

In contrast, the inter-frame difference value D for a frame immediately after a scene change, which is indicated by the point P165, is less than the threshold value T of the second embodiment for a frame immediately after a scene change, which is indicated by the point P167. This enables the determination unit 50b of the second embodiment to accurately detect that no scene changes have occurred in the frame immediately after the scene change.

In this manner, the determination unit 50b according to the second embodiment can reliably determine, for a panning scene immediately after a scene change, which the determination unit 50a according to the first embodiment can possibly erroneously detect, that no scene changes have occurred. Scene changes can thus be detected with higher accuracy than that in the first embodiment.

The flow of the video saving process of the display device 10b of this embodiment is the same as that of the display device 10a of the first embodiment, and a description of the process is thus omitted.

The flow of the video reproduction process of the display device 10b of this embodiment is also the same as that of the display device 10a of the first embodiment, and a description of the process is thus omitted.

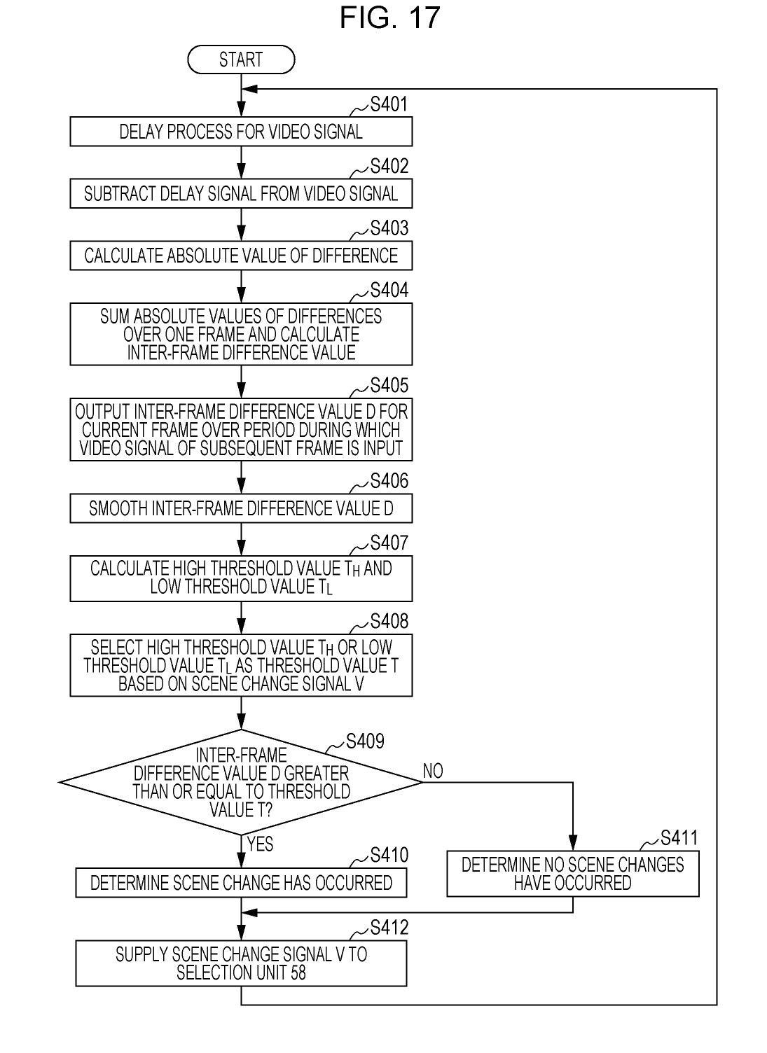

FIG. 17 is a flowchart illustrating an example of the flow of a process of the scene change detection unit 12b according to the second embodiment. The processing of step S401 to step S406 is the same as the processing of step S201 to step S206 in FIG. 10, and a description of the process is thus omitted.

In step S407 in FIG. 17, the threshold value calculation unit 51b calculates a high threshold value T_{H} and a low threshold value T_{L} (step S407). Then, the second selection unit 58 selects one of the high threshold value T_{H} and the low threshold value T_{L} as a threshold value T in accordance with the scene change signal V supplied from the holding unit 60 (step S408). Then, the comparison unit 59b determines whether or not the inter-frame difference value D is greater than or equal to the threshold value T (step S409).

If the inter-frame difference value D is greater than or equal to the threshold value T (YES in step S409), the comparison unit 59b determines that a scene change has occurred in the target frame (step S410), and supplies the scene change signal V with value 1 to the video storage processing unit 21. On the other hand, if the inter-frame difference value D is less than the threshold value T (NO in step S409), the comparison unit 59b determines that no scene changes have occurred in the target frame (step S410), and supplies the scene change signal V with value 0 to the video storage processing unit 21.

Then, the second holding unit 60 loads the scene change signal V indicating the determination result obtained by the comparison unit 59b at the next rising edge of the clock signal, and supplies the loaded signal to the second selection unit 58 (step S412). Then, the process returns to step S401. Then, the process of this flowchart ends.

As described above, if the scene change detection unit 12b of this embodiment determines that a scene change has occurred in the target frame, the threshold value T for the frame immediately after the target frame is set to be higher than the low threshold value T_{L} that is based on the comparative value Da for the frame immediately after the target frame. Accordingly, the scene change detection unit 12b can determine that a panning scene is not a scene change even if the panning scene begins immediate after a scene change. The scene change detection accuracy can thus be increased.

The scene change detection unit 12b of this embodiment changes a threshold value T from the low threshold value T_{L} to the high threshold value T_{H} only for a frame immediately after a frame determined to be a scene change. However, this is not meant in a limiting sense, and threshold values T may be changed from the low threshold value T_{L} to the high threshold value T_{H} for a predetermined number of frames, counting from a frame immediately after a frame determined to be a scene change.

In this case, if the comparison unit 59b determines that a scene change has occurred in the frame preceding the target frame, the second selection unit 58 selects the high threshold value T_{H} as the threshold value T for the target frame.

### Third Embodiment

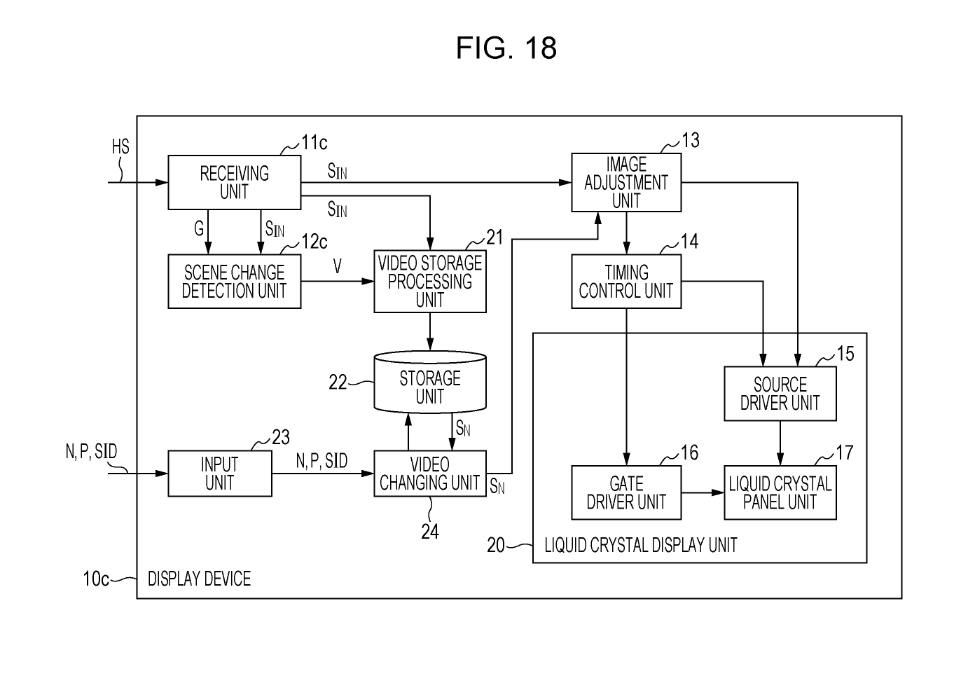

Next, a third embodiment of the present invention will be described. FIG. 18 is a schematic block diagram of a display device 10c according to the third embodiment. Elements common to those in FIG. 1 are assigned the same numerals, and will not be described in detail herein.

The configuration of the display device 10c in FIG. 18 is different from the configuration of the display device 10a in FIG. 1 in that the receiving unit 11 is replaced with a receiving unit 11c and the scene change detection unit 12a is replaced with a scene change detection unit 12c.

The receiving unit 11c performs a process similar to that of the receiving unit 11, and additionally performs the following process. For example, the receiving unit 11c decodes a digital broadcasting wave with electronic program guide (EPG) data carried thereon, and also decodes the electronic program guide data. The term “electronic program guide”, as used herein, refers to a guide to broadcast programs displayed on a television screen or the like. The receiving unit 11c supplies a program signal G indicating the electronic program guide data obtained by decoding to a signal acquisition unit 41.

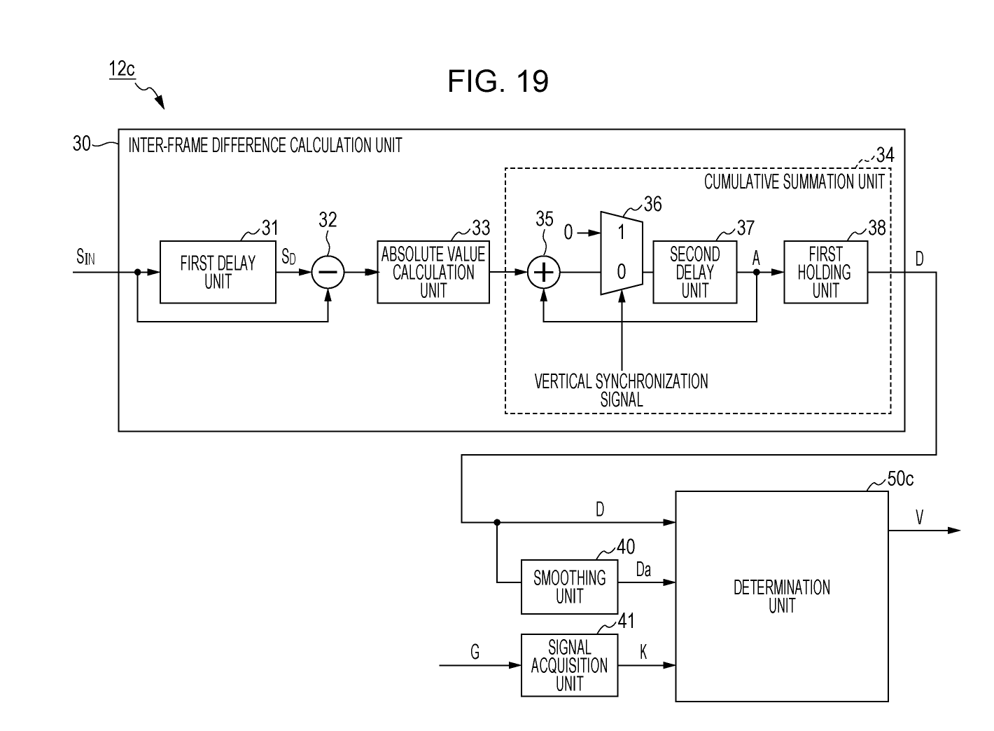

FIG. 19 is a schematic block diagram of the scene change detection unit 12c according to the third embodiment. Elements common to those in FIG. 3 are assigned the same numerals, and will not be described in detail herein.

The configuration of the scene change detection unit 12c in FIG. 19 is different from the configuration of the scene change detection unit 12a in FIG. 3 in that the signal acquisition unit 41 is further included and the determination unit 50a is replaced with a determination unit 50c.

The signal acquisition unit 41 generates a known scene change signal indicating a known scene change. A signal concerning a change of a scene will now be described here in the context of a program signal G indicating an electronic program guide (EPG), by way of example. For example, the signal acquisition unit 41 acquires a program signal G indicating an electronic program guide (EPG) supplied from the receiving unit 11c. The signal acquisition unit 41 generates a known scene change signal K based on the acquired program signal G, and supplies the generated known scene change signal K to the determination unit 50c. Here, the known scene change signal K is a signal indicating whether or not a scene has changed, and indicates 1 when a scene has changed and indicates 0 when a scene has not changed, for example.

For example, the signal acquisition unit 41 sets the value of the known scene change signal K to 1 at the start time or end time of a given program. The reason for this is as follows. At the start time of the given program, a transition from the previous program or a commercial to the given program occurs. Thus, it can be predicted in advance that a scene change will occur. At the end time of the given program, likewise, a transition from the given program or a commercial to the next program occurs. Thus, it can be predicted in advance that a scene change will occur.

On the other hand, for example, the signal acquisition unit 41 sets the value of the known scene change signal K to 0 at a time other than the start time and end time of the given program within a time zone in which the given program is broadcast. The reason for this is as follows. During the broadcasting of the program, a scene change may or may not exist, and it is thus difficult to determine in advance whether or not a scene change will occur.

In this embodiment, digital broadcasting is assumed. By way of example, the signal acquisition unit 41 detects the start time and end time of a program indicated by a video signal S_{IN} from the signal indicating the electronic program guide supplied from the receiving unit 11.

The signal acquisition unit 41 sets the known scene change signal K to a value indicating a scene change (for example, 1) at the detected start time or end time of the program, and sets the known scene change signal K to a value indicating no scene change (for example, 0) at the other times. Then, the signal acquisition unit 41 supplies the generated known scene change signal K to the determination unit 50c.

For example, in the case of analog broadcasting, the signal acquisition unit 41 may acquire program schedule information via a specific broadcast station called a host station or via the Internet.

The signal acquisition unit 41 further detects chapters in video recorded on a recording medium such as a DVD. Here, the term “chapter” refers to a segment in video. A chapter is set at, for example, a transition from one scene to another or a transition from one story to another. The signal acquisition unit 41 may set the known scene change signal K to a value indicating a scene change (for example, 1) when a chapter is detected, and set the known scene change signal K to a value indicating no scene change (for example, 0) when no chapter is detected.

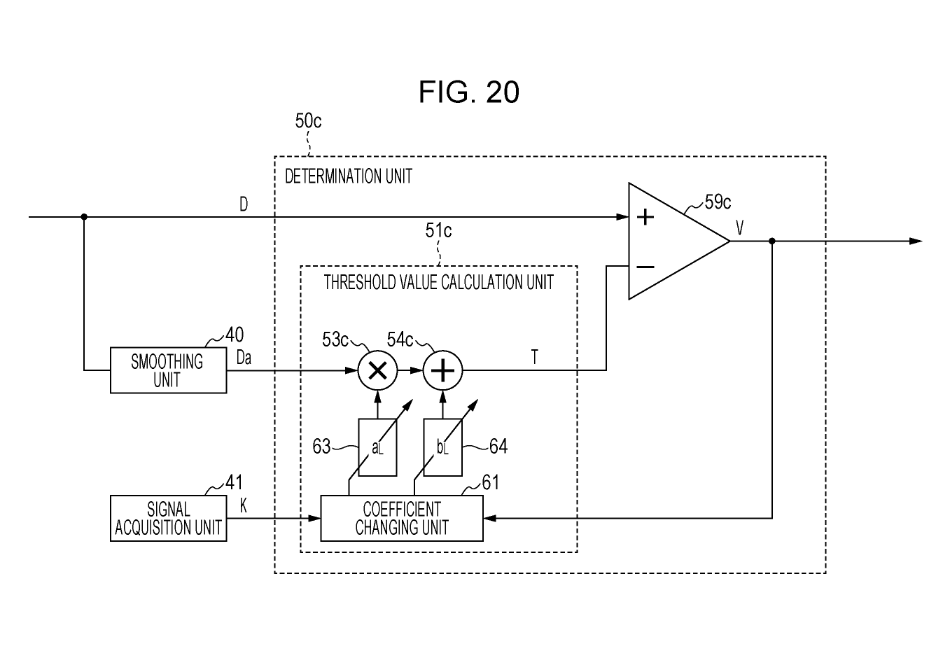

FIG. 20 is a schematic block diagram of the determination unit 50c according to the third embodiment. Elements common to those in FIG. 5 are assigned the same numerals, and will not be described in detail herein. The configuration of the determination unit 50c of FIG. 20 is different from the configuration of the determination unit 50a of FIG. 5 in that the threshold value calculation unit 51 is replaced with a threshold value calculation unit 51c and the comparison unit 59 is replaced with a comparison unit 59c.

The threshold value calculation unit 51c calculates a threshold value T in accordance with the known scene change signal K supplied from the signal acquisition unit 41, the scene change signal V supplied from the comparison unit 59c, and the signal indicating the comparative value Da supplied from the smoothing unit Da, and supplies a signal indicating the calculated threshold value T to the comparison unit 59c. Here, the threshold value calculation unit 51c includes a first multiplication unit 53c, a second summation unit 54c, a coefficient changing unit 61, a gradient storage unit 63, and an intercept storage unit 64.

The gradient storage unit 63 stores information indicating a gradient a_{L}.

The intercept storage unit 64 stores information indicating an intercept b_{L}.

The coefficient changing unit 61 changes information indicating the gradient a_{L} stored in the gradient storage unit 63 and information indicating the intercept b_{L} stored in the intercept storage unit 64 in accordance with the known scene change signal K supplied from the signal acquisition unit 41 and the scene change signal V supplied from the comparison unit 59c. Specifically, for example, the coefficient changing unit 61 calculates a coefficient such as the gradient a_{L} and the intercept b_{L} so that the coefficient has an appropriate value, using a perceptron learning algorithm that uses a teacher signal, such that the scene change signal V shows the teacher signal, where the teacher signal represents the known scene change signal K.

The coefficient changing unit 61 further changes the coefficients described above, for example, if the scene change signal V does not indicate a scene change (for example, value 0) when the known scene change signal K indicates a scene change (for example, value 1).

Specifically, the coefficient changing unit 61 changes the coefficients described above, for example, if the comparison unit 59c does not determine a scene change at the detected start time or end time of the program. Accordingly, the coefficient changing unit 61 changes the coefficients described above when the determination of the comparison unit 59c is wrong. Thus, the threshold value T on which the determination of whether or not a scene change has occurred (whether or not the target frame is the first frame in a video scene that has changed) is based can be changed to an appropriately value. As a result, the determination unit 50c determines whether or not a scene change has occurred in the target frame (whether or not the target frame is the first frame in a video scene that has changed), using the threshold value T set to an appropriate value. Thus, whether or not a scene change exists can be determined with high accuracy.

The coefficient changing unit 61 further updates the information indicating the gradient a_{L} stored in the gradient storage unit 63 with the calculated gradient a_{L}. The coefficient changing unit 61 also updates the information indicating the intercept b_{L} stored in the intercept storage unit 64 with the calculated gradient b_{L}.

Accordingly, the threshold value calculation unit 51c applies the comparative value Da to a function having the coefficients changed by the coefficient changing unit 61 to calculate a threshold value T.

The first multiplication unit 53c reads a signal indicating the gradient a_{L} from the gradient storage unit 63, and multiplies the comparative value Da supplied from the smoothing unit 40 by the read signal indicating the gradient a_{L}. The first multiplication unit 53c supplies the signal obtained by multiplication to the second summation unit 54c.

The second summation unit 54c reads a signal indicating the intercept b_{L} from the intercept storage unit 64, and adds the read signal indicating the intercept b_{L} to the signal obtained by multiplication, which is supplied from the first multiplication unit 53c. The second summation unit 54c supplies the summed signal to the comparison unit 59c as a signal indicating the threshold value T.

The comparison unit 59c generates a scene change signal V on the basis of the comparison between the signal indicating the inter-frame difference value D supplied from the cumulative summation unit 34 and the signal indicating the threshold value T supplied from the second summation unit 54c of the threshold value calculation unit 51c. Specifically, the comparison unit 59c sets the value indicated by the scene change signal V to 1, for example, when the inter-frame difference value D is greater than or equal to the threshold value T. Here, the scene change signal V with value 1 indicates that a scene change has occurred. On the other hand, the comparison unit 59c sets the value indicated by the scene change signal V to 0 when the inter-frame difference value D is less than the threshold value T. Here, the scene change signal V with value 0 indicates that no scene changes have occurred.

Then, the comparison unit 59c supplies the generated scene change signal V to the coefficient changing unit 61 and the video storage processing unit 21. Here, the comparison unit 59c is, for example, a comparator.

The signal acquisition unit 41 may detect chapters from video recorded on a recording medium such as a DVD. In this case, the coefficient changing unit 61 may change the coefficients described above if the signal acquisition unit 41 detects a chapter and if the comparison unit 59c does not determine a scene change.

Accordingly, the coefficient changing unit 61 changes the coefficients described above if the determination of the comparison unit 59c is wrong. Thus, the threshold value T on which the determination of whether or not a scene change has occurred (whether or not the target frame is the first frame in a video scene that has changed) is based can be changed to an appropriate value. As a result, the determination unit 50c determines whether or not a scene change has occurred in the target frame (whether or not the target frame is the first frame in a video scene that has changed), using the threshold value T set to an appropriate value. Thus, whether or not a scene change exists can be determined with high accuracy.

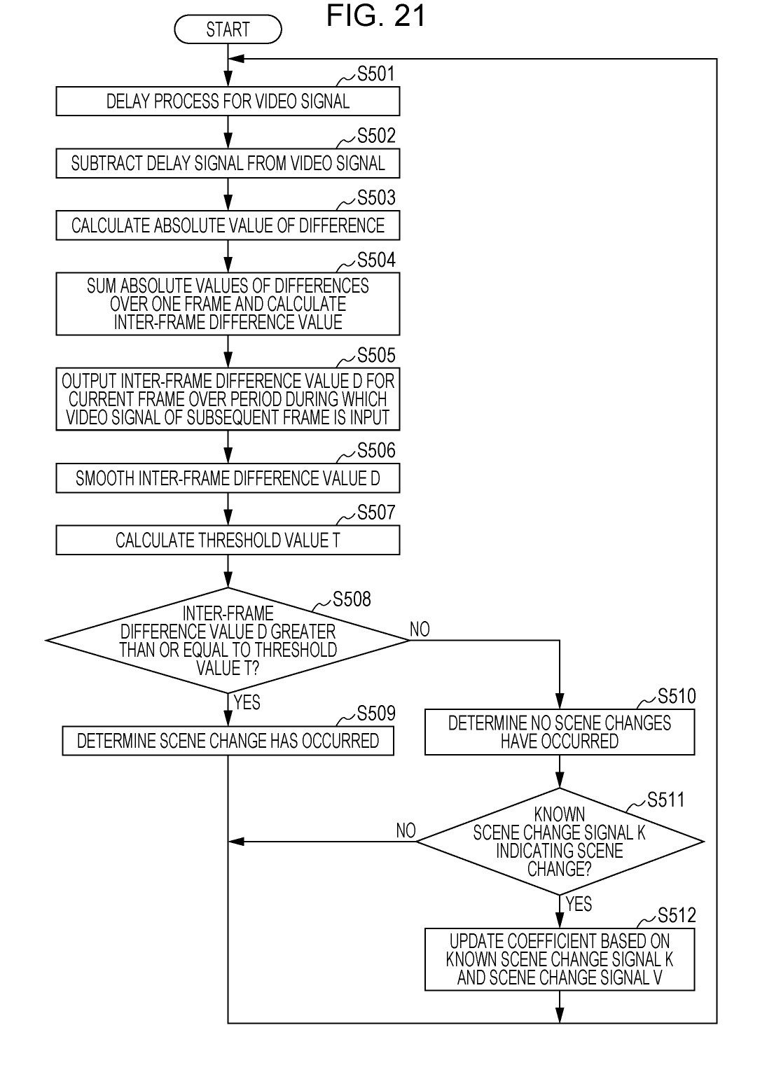

FIG. 21 is a flowchart illustrating an example of the flow of a process of the scene change detection unit 12c according to the third embodiment. The processing of step S501 to step S506 is the same as the processing of step S201 to step S206 in FIG. 10, and a description of the process is thus omitted.

In step S507 in FIG. 21, the threshold value calculation unit 51c calculates a threshold value T based on the comparative value Da (step S507). Then the comparison unit 59c determines whether or not the inter-frame difference value D of the target frame is greater than or equal to the threshold value T (step S508). If the inter-frame difference value D of the target frame is greater than or equal to the threshold value T (YES in step S508), the comparison unit 59c determines that a scene change has occurred in the target frame (step S509), and supplies the scene change signal V with value 1 to the video storage processing unit 21. Then, the scene change detection unit 12c returns to the processing of step S501.

On the other hand, if it is determined in step S508 that the inter-frame difference value D of the target frame is less than the threshold value T (NO in step S508), the comparison unit 59c determines that no scene changes have occurred in the target frame (step S510), and supplies the scene change signal V with value 0 to the video storage processing unit 21.

Then, the coefficient changing unit 61 determines whether or not the known scene change signal K supplied from the signal acquisition unit 41 indicates a scene change (step S511). If the known scene change signal K indicates a scene change (YES in step S511), the coefficient changing unit 61 updates a coefficient in accordance with the known scene change signal K and the scene change signal V supplied from the comparison unit 59c (step S512). In other words, the coefficient changing unit 61 updates the coefficients if the comparison unit 59c determines that no scene changes have occurred although the known scene change signal K indicates a scene change, that is, if the determination of the comparison unit 59c is wrong. Then, after the coefficient is updated, the scene change detection unit 12c returns to the processing of step S501. On the other hand, if the known scene change signal K does not indicate a scene change (NO in step S511), the scene change detection unit 12c returns to the processing of step S501. Then, the process of this flowchart ends.

As described above, the determination unit 50c of the scene change detection unit 12c of the third embodiment updates a coefficient in accordance with the known scene change signal K acquired by the signal acquisition unit 41 and the scene change signal V generated by the comparison unit 59c. The update of the coefficient allows the determination unit 50c to set the threshold value T on which the determination of whether or not a scene change has occurred is based to an appropriate value. As a result, the determination unit 50c determines whether or not a scene change has occurred in the target frame (whether or not the target frame is the first frame in a video scene that has changed), using the threshold value T set to an appropriate value. Thus, whether or not a scene change exists can be determined with high accuracy.

Furthermore, the coefficient changing unit 61 changes a coefficient if the comparison unit 59c mistakenly determines that a scene change has occurred although the known scene change signal K does not indicate a scene change or if the comparison unit 59c mistakenly determines that a scene change does not exist although the known scene change signal K indicates a scene change. Accordingly, the coefficient changing unit 61 changes a coefficient only when the determination of the comparison unit 59c is wrong. The coefficient can be changed to be appropriate, resulting in an increase in the accuracy of the determination by the determination unit 50c of whether or not a scene change has occurred (whether or not the target frame is the first frame in a video scene that has changed).

### Fourth Embodiment

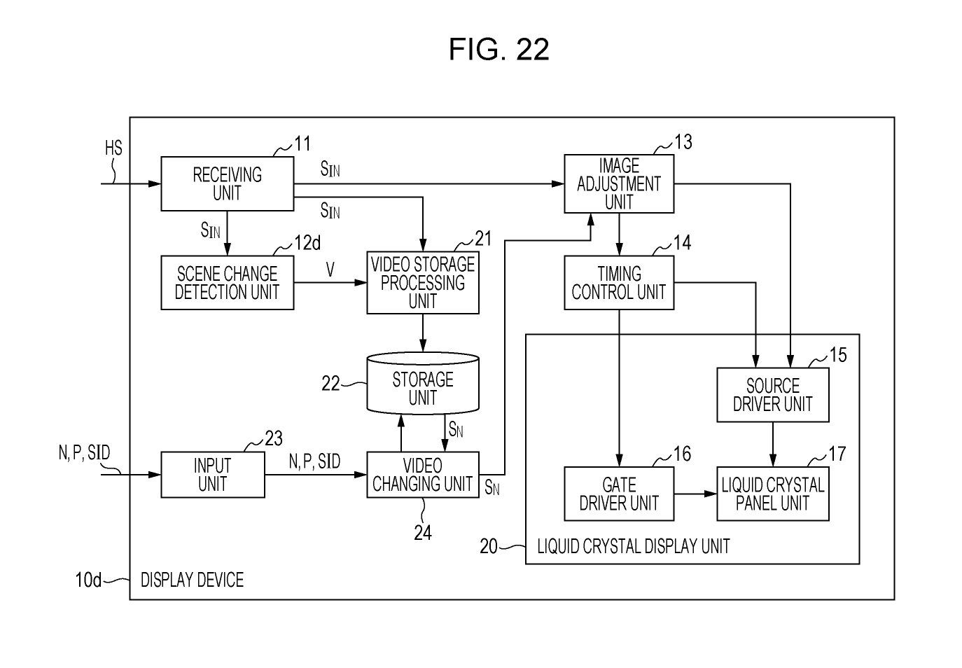

Next, a fourth embodiment of the present invention will be described. FIG. 22 is a schematic block diagram of a display device 10d according to the fourth embodiment. Elements common to those in FIG. 1 are assigned the same numerals, and will not be described in detail herein.

The configuration of the display device 10d in FIG. 22 is different from the configuration of the display device 10a in FIG. 1 in that the scene change detection unit 12a is replaced with a scene change detection unit 12d.

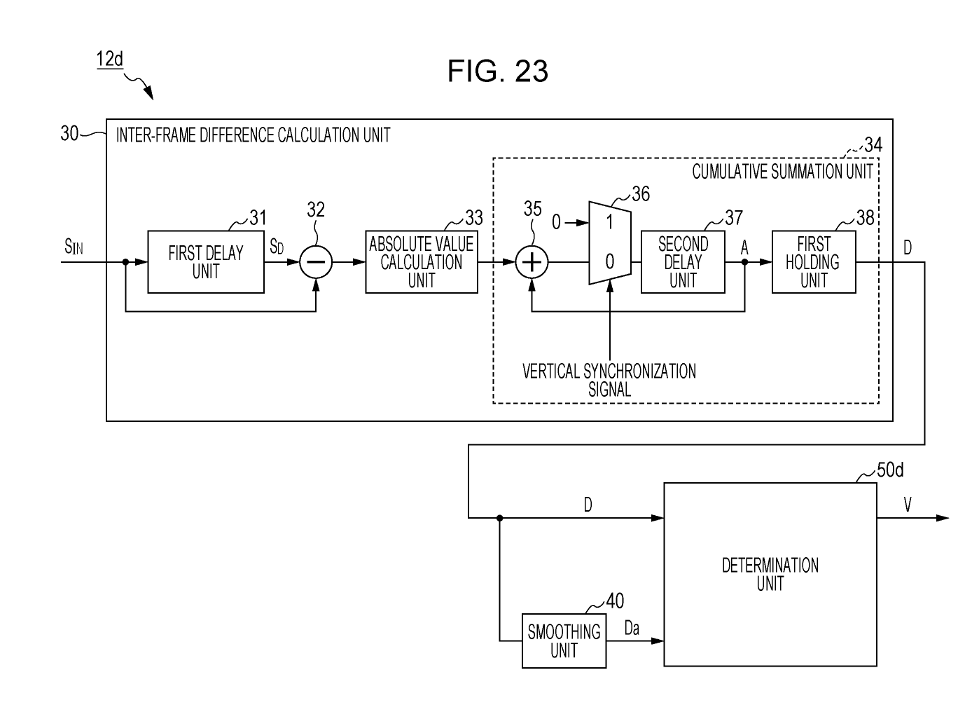

FIG. 23 is a schematic block diagram of the scene change detection unit 12d according to the fourth embodiment. Elements common to those in FIG. 3 are assigned the same numerals, and will not be described in detail herein.

The configuration of the scene change detection unit 12d in FIG. 23 is different from the configuration of the scene change detection unit 12a in FIG. 3 in that the determination unit 50a is replaced with a determination unit 50d.

The determination units (50, 50b, 50c) of the first to third embodiments are each a linear separable two-class classifier. In contrast, the determination unit 50d of this embodiment is a non-linear separable two-class classifier.

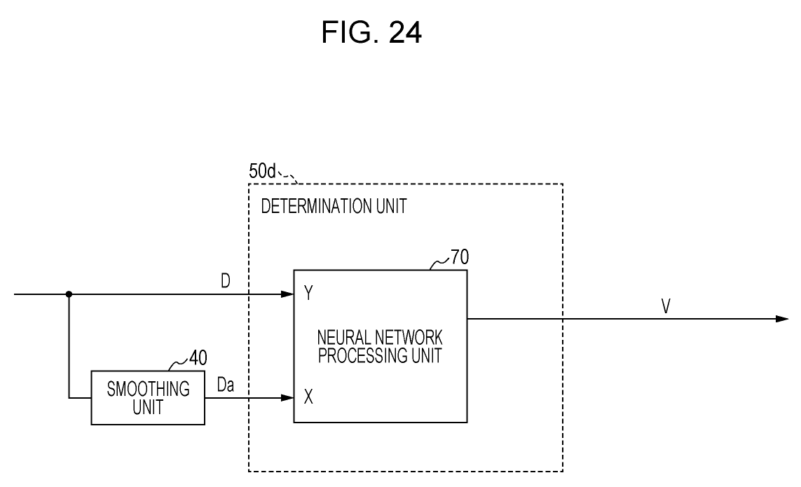

FIG. 24 is a schematic block diagram of the determination unit 50d according to the fourth embodiment. The determination unit 50d includes a neural network processing unit 70.

The neural network processing unit 70 generates a scene change signal V in accordance with the signal indicating the inter-frame difference value D supplied from the cumulative summation unit 34 and the signal indicating the comparative value Da supplied from the smoothing unit 40. That is, the neural network processing unit 70 applies the inter-frame difference value D and the comparative value Da to a pre-established neural network to determine whether or not a scene change has occurred in the target frame (whether or not the target frame is the first frame in a video scene that has changed).

Specifically, for example, the neural network processing unit 70 inputs input X and input Y to a preset two-input one-output neural network, with the input X being the comparative value Da and the input Y being the inter-frame difference value D. The neural network processing unit 70 sets the output of the neural network as the scene change signal V. Then, the neural network processing unit 70 supplies the generated scene change signal V to the video storage processing unit 21.

The two-input one-output neural network is an example, and this example is not given in a limiting sense.

The neural network may have a learning function. In this case, for example, like the scene change detection unit 12c according to the third embodiment, the scene change detection unit 12d of this embodiment may further include a signal acquisition unit 41, and the signal acquisition unit 41 may supply a known scene change signal K to the neural network processing unit 70. Then, the neural network processing unit 70 may update the weights between neurons in the neural network using the known scene change signal K supplied from the signal acquisition unit 41 as a teacher signal.

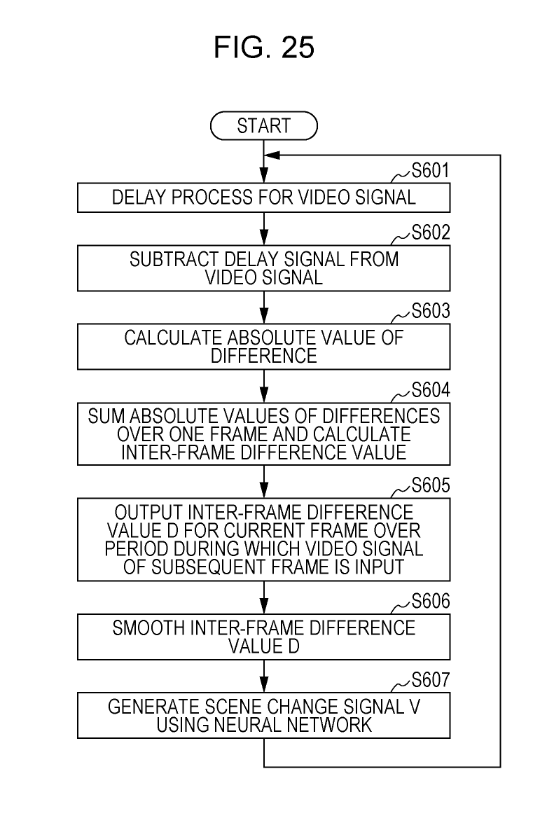

FIG. 25 is a flowchart illustrating an example of the flow of a process of the scene change detection unit 12d according to the fourth embodiment. The processing of step S601 to step S606 is the same as the processing of step S201 to step S206 in FIG. 10, and a description of the process is thus omitted.

Then, the neural network processing unit 70 applies the inter-frame difference value D and the comparative value Da to a pre-established neural network to generate a scene change signal V (step S607), and supplies the scene change signal V to the video storage processing unit 21. Then, the scene change detection unit 12d returns to the processing of step S601. Then, the process of this flowchart ends.

As described above, the determination unit 50d of the scene change detection unit 12d of the fourth embodiment applies the inter-frame difference value D and the comparative value Da to a neural network to generate a scene change signal V. Accordingly, the determination unit 50d may classify an inter-frame difference value D into two groups, that is, a group for occurrence of a scene change and a group for no occurrence of a scene change, using the non-linear function of the comparative value Da. Thus, even if it is difficult to classify an inter-frame difference value D into two groups using the linear function of the comparative value Da, the determination unit 50d can classify the inter-frame difference value D into two groups. This enables the scene change detection unit 12d to detect occurrence of a scene change (the first frame in a video scene that has changed) even if it is difficult to classify an inter-frame difference value D into two groups using the linear function of the comparative value Da. Thus, scene changes can be detected with high accuracy.

In addition, as is common to the respective embodiments, the determination units (50a, 50b, 50c, and 50d) each classify the inter-frame difference value D of the target frame into two groups in accordance with the comparative value Da input from the smoothing unit 40, thereby determining whether or not a scene change has occurred in the target frame (whether or not the target frame is the first frame in a video scene that has changed).

Accordingly, the determination units (50, 50b, 50c, and 50d) can each classify the inter-frame difference value D into two groups, that is, a group for occurrence of a scene change and a group for no occurrence of a scene change, in accordance with the comparative value Da, and can thus determine whether or not a scene change has occurred in the target frame (whether or not the target frame is the first frame in a video scene that has changed) with high accuracy.

The scene change detection units (12a, 12b, 12c, and 12d) of the respective embodiments have been described as part of the display devices (10a, 10b, 10c, and 10d). Each of the scene change detection units (12a, 12b, 12c, and 12d) may be implemented as a separate device.

Furthermore, a program for executing each of the processing operations of the scene change detection units (12a, 12b, 12c, and 12d) of the respective embodiments may be recorded on a computer-readable recording medium. The program recorded on the recording medium may be loaded into a computer system and executed to perform the various processing operations described above for the associated scene change detection unit (12a, 12b, 12c, or 12d).

The “computer system” referred to herein may include an OS and hardware such as peripheral devices. In addition, the “computer system” is assumed to include a homepage providing environment (or displaying environment) when a WWW system is used. The “computer-readable recording medium” refers to a storage device, including a flexible disk, a magneto-optical disk, a ROM, a writable non-volatile memory such as a flash memory, a portable medium such as a CD-ROM, and a built-in hard disk of the computer system.

Furthermore, the “computer-readable recording medium” is assumed to include a medium that holds a program for a constant period of time, like a volatile memory (for example, a DRAM (Dynamic Random Access Memory)) inside a computer system serving as a server or a client when the program is transmitted via a network such as the Internet or a communication line such as a telephone line. The program described above may be transmitted from a computer system in which this program is stored in a storage device or the like to another computer system via a transmission medium or using a transmission wave in a transmission medium. Here, the “transmission medium” on which a program is transmitted refers to a medium having a function of transmitting information, like a network (communication network) such as the Internet or a communication line (communication cable) such as a telephone line. Moreover, the program described above may be a program for implementing some of the functions described above. The program described above may also be a program, called a differential file (differential program), capable of implementing the functions described above in combination with a program already recorded on a computer system.

While some embodiments of the present invention have been described in detail with reference to the drawings, specific configurations are not limited to those in the foregoing embodiments, and may be modified in design without departing from the scope of this invention.

### REFERENCE SIGNS LIST

10a, 10b display device
11 receiving unit
12a, 12b, 12c, 12d scene change detection unit
13 image adjustment unit
14 timing control unit
15 source driver unit
16 gate driver unit
17 liquid crystal panel unit
20 liquid crystal display unit
21 video storage processing unit
22 storage unit
23 input unit
24 video changing unit
30 inter-frame difference calculation unit
31 first delay unit (delay unit)
32 difference calculation unit
33 absolute value calculation unit
34 cumulative summation unit
35 first summation unit
36 first selection unit
37 second delay unit
38 first holding unit
40 smoothing unit (adjustment unit)
50a, 50b, 50c, 50d determination unit
51, 51b, 51c threshold value calculation unit
52b low threshold value calculation unit
53, 53c first multiplication unit
54, 54c second summation unit
55b high threshold value calculation unit
56 second multiplication unit
57 third summation unit
58 second selection unit (selection unit)
59, 59b, 59c comparison unit
60 second holding unit
61 coefficient changing unit
63 gradient storage unit
64 intercept storage unit
70 neural network processing unit

1. A scene change detection device comprising:
an inter-frame difference calculation unit configured to calculate, based on an image signal, an inter-frame difference value corresponding to an inter-frame pixel value difference; and
a determination unit configured to determine whether or not a target frame is the first frame in a video scene that has changed, by referring to a first value and a comparative value, the first value being an inter-frame difference value between the target frame and a frame other than the target frame, the comparative value being derived from a second value that is an inter-frame difference value between frames other than the target frame.

2. The scene change detection device according to claim 1, wherein the comparative value is a value that is based on an inter-frame difference value for neighboring frames of the target frame.

3. The scene change detection device according to claim 1, wherein the comparative value is a value that is based on an inter-frame difference value for a series of frames adjacent to the target frame.

4. The scene change detection device according to claim 1, wherein the comparative value is a value that is based on an inter-frame difference value for frames preceding the target frame.

5. The scene change detection device according to claim 1, further comprising
an adjustment unit configured to adjust a value of the inter-frame difference value of the target frame in accordance with the inter-frame difference value between frames other than the target frame to calculate the comparative value,
wherein the determination unit determines whether or not the target frame is the first frame in a video scene that has changed, in accordance with the inter-frame difference value of the target frame and the comparative value calculated by the adjustment unit.

6. The scene change detection device according to claim 1, wherein the determination unit determines whether or not the target frame is the first frame in a video scene that has changed, by classifying the inter-frame difference value of the target frame into two groups in accordance with the comparative value.

7. The scene change detection device according to claim 1, wherein the determination unit includes
a threshold value calculation unit configured to calculate a threshold value based on the comparative value, and
a comparison unit configured to determine whether or not the target frame is the first frame in a video scene that has changed, based on a comparison between the inter-frame difference value and the threshold value calculated by the threshold value calculation unit.

8. The scene change detection device according to claim 7, wherein the threshold value calculation unit calculates the threshold value so that the threshold value increases as the comparative value increases.

9. The scene change detection device according to claim 7, wherein the threshold value calculation unit sets a threshold value for a frame subsequent to the target frame to be higher than a threshold value that is based on the comparative value for the frame subsequent to the target frame in a case where the determination unit determines that the target frame is the first frame in a video scene that has changed.

10. The scene change detection device according to claim 9, wherein the threshold value calculation unit sets a threshold value for a frame subsequent to the target frame to be equal to a threshold value that is based on the comparative value for the frame subsequent to the target frame in a case where the determination unit determines that the target frame is not the first frame in a video scene that has changed.

11. The scene change detection device according to claim 7, wherein the threshold value calculation unit includes
a low threshold value calculation unit configured to calculate a low threshold value based on the comparative value,
a high threshold value calculation unit configured to calculate, based on the comparative value, a high threshold value larger than the low threshold value calculated by the low threshold value calculation unit based on the comparative value, and
a selection unit configured to select the high threshold value as the threshold value for the target frame in a case where the comparison unit determines that a scene change has occurred in a frame preceding the target frame, and selects the low threshold value as the threshold value for the target frame in a case where the comparison unit determines that no scene changes have occurred in a frame preceding the target frame.

12. The scene change detection device according to claim 11, wherein the low threshold value calculation unit calculates the low threshold value by applying the comparative value to a predetermined first function,
the high threshold value calculation unit calculates the high threshold value by applying the comparative value to a predetermined second function, and
in a case where the comparative value is a value greater than or equal to 0, the second function has a return value greater than or equal to a return value of the first function with respect to an equal comparative value.

13. The scene change detection device according to claim 7, further comprising
a signal acquisition unit configured to acquire a known scene change signal indicating a known scene change,
wherein the threshold value calculation unit calculates a threshold value in accordance with the comparative value, the known scene change signal acquired by the signal acquisition unit, and a determination result obtained by the comparison unit.

14. The scene change detection device according to claim 13, wherein
the threshold value calculation unit includes a coefficient changing unit configured to change a coefficient of a third function in accordance with the known scene change signal and a determination result obtained by the comparison unit, and
the threshold value calculation unit calculates a threshold value by applying the comparative value to the third function having the coefficient changed by the coefficient changing unit.

15. The scene change detection device according to claim 7, wherein the determination unit determines whether or not the target frame is the first frame in a video scene that has changed, by applying the inter-frame difference value of the target frame and the comparative value to a pre-established neural network.

16. The scene change detection device according to claim 1, wherein the inter-frame difference calculation unit includes
a delay unit configured to delay an image signal by one or more frames,
a difference calculation unit configured to compute a difference between an input and output of the delay unit,
an absolute value calculation unit configured to calculate an absolute value of the difference, and
a cumulative summation unit configured to calculate a sum value of absolute values of differences within an effective pixel section.

17. A display device comprising the scene change detection device according to claim 1.

18. A scene change detection method executed by a scene change detection device, comprising:
an inter-frame difference calculation procedure of calculating, based on an image signal, an inter-frame difference value corresponding to an inter-frame pixel value difference; and
a determination procedure of determining whether or not a target frame is the first frame in a video scene that has changed, by referring to a first value and a comparative value, the first value being an inter-frame difference value between the target frame and a frame other than the target frame, the comparative value being derived from a second value that is an inter-frame difference value between frames other than the target frame.

19. (canceled)
